(19) United States
(12) Patent Application Publication
(10) Pub. No.: US 2026/0172127 A1
(43) Pub. Date: Jun. 18, 2026

(54) Wireless Device, Network Node, and Methods Performed Thereby, for Handling Absence of an Active Connection

(71) Applicant: Telefonaktiebolaget LM Ericsson (publ), Stockholm (SE)

(72) Inventors: Oskar Myrberg, Norrköping (SE); Andreas Höglund, Solna (SE); Revathy Narayanan, Sollentuna (SE); Jan Christoffersson, Luleå (SE)

(21) Appl. No.: 19/129,478

(22) PCT Filed: Jan. 19, 2024
(86) PCT No.: PCT/SE2024/050043

§ 371 Date: May 13, 2025

Related U.S. Application Data
(60) Provisional application No. 63/480,697, filed on Jan. 20, 2023.

(51) Int. Cl. H04B 17/318; H04W 68/02; H04W 72/21; H04W 74/0833; H04W 76/20

(52) U.S. Cl. CPC H04B 17/328; H04W 68/02; H04W 72/21; H04W 74/0833; H04W 76/20

(57) ABSTRACT

A method, performed by a wireless device (130), for handling absence of an active connection to a network node (110). The wireless device (130) and the network node (110) operate in a wireless communications network (100). The wireless device (130) obtains (201) a first indication from the network node (110) indicating that the wireless device (130) is to perform an estimation, of a quality of a radio channel between the wireless device (130) and the network node (110), during a random access procedure in the absence of an active connection to the network node (110) and prior to receiving data from the network node (110). The wireless device (130) estimates (203), in the absence of the active connection, the quality of the radio channel and then sends (204), still in the absence of the active connection, another indication to the network node (110) indicating the estimated quality of the radio channel. Publ.

### TECHNICAL FIELD

The present disclosure relates generally to a wireless device and methods performed thereby for handling absence of an active connection to a network node. The present disclosure further relates generally to a network node and methods performed thereby, for handling the absence of an active connection to a wireless device.

### BACKGROUND

Wireless devices within a wireless communications network may be e.g., User Equipments (UEs), stations (STAs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The wireless communications network covers a geographical area which may be divided into cell areas, each cell area being served by a network node, which may be an access node such as a radio network node, radio node or a base station, e.g., a Radio Base Station (RBS), which sometimes may be referred to as e.g., gNB, evolved Node B (“eNB”), “eNodeB”, “NodeB”, “B node”, Transmission Point (TP), or Base Transceiver Station (BTS), depending on the technology and terminology used. The base stations may be of different classes such as e.g., Wide Area Base Stations, Medium Range Base Stations, Local Area Base Stations, Home Base Stations, pico base stations, etc. . . . , based on transmission power and thereby also cell size. A cell is the geographical area where radio coverage is provided by the base station or radio node at a base station site, or radio node site, respectively. One base station, situated on the base station site, may serve one or several cells. Further, each base station may support one or several communication technologies. The base stations communicate over the air interface operating on radio frequencies with the terminals within range of the base stations. The wireless communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

The standardization organization 3GPP is currently in the process of specifying a New Radio Interface called NR or 5G-UTRA, as well as a Fifth Generation (5G) Packet Core Network (CN), which may be referred to as Next Generation (NG) Core Network, abbreviated as NG-CN, NGC, 5G CN or 5G Core (5GC). NG may be understood to refer to the interface/reference point between the Radio Access Network (RAN) and the CN in 5G/NR. In a 5G System (5GS), a radio base station in NR may be referred to as a gNB or 5G Node B. An NR UE may be referred to as an nUE.

### Internet of Things (IoT)

The Internet of Things (IoT) may be understood as an internetworking of communication devices, e.g., physical devices, vehicles, which may also be referred to as “connected devices” and “smart devices”, buildings and other items-embedded with electronics, software, sensors, actuators, and network connectivity that may enable these objects to collect and exchange data. The IoT may allow objects to be sensed and/or controlled remotely across an existing network infrastructure.

“Things,” in the IoT sense, may refer to a wide variety of devices such as heart monitoring implants, biochip transponders on farm animals, electric clams in coastal waters, automobiles with built-in sensors, DNA analysis devices for environmental/food/pathogen monitoring, or field operation devices that may assist firefighters in search and rescue operations, home automation devices such as the control and automation of lighting, heating, e.g. a “smart” thermostat, ventilation, air conditioning, and appliances such as washer, dryers, ovens, refrigerators or freezers that may use telecommunications for remote monitoring. These devices may collect data with the help of various existing technologies and then autonomously flow the data between other devices.

It is expected that in a near future, the population of IoT devices will be very large. Various predictions exist, among which one assumes that there will be >60000 devices per square kilometer, and another assumes that there will be 1000000 devices per square kilometer. A large fraction of these devices are expected to be stationary, e.g., gas and electricity meters, vending machines, etc.

### Machine Type Communication (MTC)

Machine Type Communication (MTC) has in recent years, especially in the context of the Internet of Things (IoT), shown to be a growing segment for cellular technologies. An MTC device may be a communication device, typically a wireless communication device or simply user equipment, that is a self and/or automatically controlled unattended machine and that is typically not associated with an active human user in order to generate data traffic. An MTC device may be typically simpler, and typically associated with a more specific application or purpose, than, and in contrast to, a conventional mobile phone or smart phone. MTC involves communication in a wireless communication network to and/or from MTC devices, which communication typically may be of quite different nature and with other requirements than communication associated with e.g. conventional mobile phones and smart phones. In the context of and growth of the IoT, it is evident that MTC traffic will be increasing and thus needs to be increasingly supported in wireless communication systems.

In Rel-17, Mobile Originated Small Data Transmission (MO-SDT) was introduced for NR to reduce the signaling overhead for small uplink data payloads, see RP-200954 ‘New Work Item on NR small data transmissions in INACTIVE state’. Two solutions were introduced, random access based SDT (RA-SDT) and configured grant SDT (CG-SDT). RA-SDT may be understood to mean that either legacy 4-step Random Access CHannel (RACH), or 2-step RACH, procedure may be used as a baseline but that a user-plane data payload may be appended, multiplexed with the RRCResumeRequest message, in Msg3, or MsgA. CG-SDT may be understood to mean that the UEs may be configured via Radio Resource Control (RRC) to have periodic CG-SDT occasions which may, contention-free, be used for uplink transmission. In this way, Msg1 and Msg2 may be omitted but it may be a requirement that the UE has a valid Timing Advance (TA) and is uplink synchronized to be able to use the resources for transmission.

For NarrowBand IoT (NB-IoT) and LTE for Machines (LTE-M), similar signaling optimizations for small data have been introduced through Rel-15 Early Data Transmission (EDT) and Rel-16 Preconfigured Uplink Resources (PUR). The main differences for the NR Small Data Transmission (SDT) solutions may be understood to be that the Rel-17 NR Small Data may be understood to be only to be supported for RRC INACTIVE state, may include also 2-step RACH based small data, that it may be supported by any NR UE, that is, also Mobile Broadband (MBB) UEs and not limited to IoT UEs, and support transmission of subsequent data, that is, larger payload sizes which may require more than one transmission.

LTE support for mobile terminated data (MT) was later introduced in Rel-16, that is, supporting transmissions of small data payloads in the downlink. It may be noted that for NB-IOT and LTE-M, different solutions were introduced for the IoT control-plane optimization, such as ‘Data over Non-Access Stratum (NAS)’ or DoNAS, and IoT user-plane optimizations, such as RRC suspend/resume, Control Plane EDT (CP-EDT) and User Plane EDT (UP-EDT), respectively, and that the NR solutions may be understood to resemble the UP-EDT.

Currently, MT-SDT is being introduced in Rel-18 for NR. A Rel-18 MT-SDT work item description (WID) was approved in RAN #94e, December 2021, and may be found in RP-213583. The WID contains as an objectives to specify the support for paging-triggered SDT (MT-SDT) [RAN2, RAN3]. Particularly, MT-SDT triggering mechanism for UEs in RRC_INACTIVE, supporting RA-SDT and CG-SDT as the UL response, and MT-SDT procedure for initial DL data reception and subsequent UL/DL data transmissions in RRC_INACTIVE. Data transmission in DL within paging message is not in scope of this WI.

For MO-SDT in release 17, a rough check on the radio environment was introduced, to ensure that MO-SDT was not performed in radio environments that would lead to too many retransmissions on a non-quality controlled link. This may be understood to be to not end up in a situation that may require a lot of extra signaling in RRC_INACTIVE, since it may be more effective for the network to move the UE to RRC_CONNECTED instead. The nature of MO-SDT may be understood to mean that the check may have to be done by the UE before it may make a random access, and by then, there may exist no good estimation of the uplink radio channel. The option chosen may be to perform a measurement of the downlink carriers signal strength, e.g., Reference Signal Received Power (RSRP) and use that as an estimation of the uplink radio channel quality. Even though not perfect, it may keep the UE from attempting MO-SDT in the worst cases.

For MT-SDT, there may probably be a need to perform some estimations of the radio channel as well, and some discussions have been held to re-use the RSRP check as in MO-SDT.

In EDT procedures from release 16, the triggering of a channel quality estimation was described.

According to existing methods, MT-SDT may result in wasted resources of the communications network, and/or in poor quality transmissions.

### SUMMARY

As part of the development of embodiments herein, one or more challenges with the existing technology will first be identified and discussed.

Although the received signal strength of the downlink carrier, e.g., RSRP, may give a hint of the current radio conditions to both the UE and the gNB, it may be understood to not consider the signal to noise ratio, and thus, a big part of the radio channel is left out of the equation. For the procedures of MT-SDT, there may be understood to be more network control, and there may be room in the procedure for the network to initiate a channel quality estimation by the UE and have it reported to the network.

According to the foregoing, it is an object of embodiments herein to improve the handling of absence of an active connection of a wireless device to a network node.

According to a first aspect of embodiments herein, the object is achieved by a method, performed by a wireless device. The method is for handling absence of an active connection to a network node. The wireless device and the network node operate in a wireless communications network. The wireless device obtains a first indication from the network node. The first indication indicates that the wireless device is to perform an estimation of a quality of a radio channel between the wireless device and the network node. The estimation is to be performed during a random access procedure in the absence of an active connection to the network node, and prior to the wireless device receiving data from the network node. The wireless device then estimates, based on the obtained first indication and still in the absence of the active connection to the network node, the quality of the radio channel. The wireless device then sends, based on the obtained first indication and still in the absence of the active connection to the network node, another indication to the network node. The another indication indicates the estimated quality of the radio channel.

According to a second aspect of embodiments herein, the object is achieved by a method, performed by the network node. The method is for handling the absence of an active connection to the wireless device. The network node and the wireless device operate in the wireless communications network. The network node sends the first indication to the wireless device. The first indication indicates that the wireless device is to perform the estimation of the quality of the radio channel between the wireless device and the network node. The estimation is to be performed during the random access procedure in the absence of an active connection to the wireless device, and prior to the wireless device receiving data from the network node. The network node then receives, based on the sent first indication and still in the absence of the active connection to the wireless device, the another indication from the wireless device. The another indication indicates the quality of the radio channel as estimated by the wireless device.

According to a third aspect of embodiments herein, the object is achieved by the wireless device, configured to perform the method. The wireless device may be understood to be for handling the absence of the active connection to the network node. The wireless device and the network node are configured to operate in the wireless communications network. The wireless device is configured to obtain the first indication from the network node. The first indication is configured to indicate that the wireless device is to perform the estimation of the quality of the radio channel between the wireless device and the network node. The estimation is configured to be performed during a random access procedure in the absence of an active connection to the network node and prior to the wireless device receiving data from the network node. The wireless device is also configured to estimate, based on the first indication configured to be obtained and still in the absence of the active connection to the network node, the quality of the radio channel. The wireless device is further configured to send, based on the first indication configured to be obtained and still in the absence of the active connection to the network node, the another indication to the network node. The another indication is configured to indicate the quality of the radio channel configured to be estimated.

According to a fourth aspect of embodiments herein, the object is achieved by the network node, configured to perform the method. The network node may be understood to be for handling the absence of an active connection to the wireless device. The network node and the wireless device are configured to operate in the wireless communications network. The network node is configured to send the first indication to the wireless device. The first indication is configured to indicate that the wireless device is to perform the estimation of the quality of the radio channel between the wireless device and the network node. The estimation is configured to be performed during a random access procedure in the absence of an active connection to the wireless device and prior to the wireless device receiving data from the network node. The network node is also configured to receive, based on the first indication configured to be sent and still in the absence of the active connection to the wireless device, the another indication from the wireless device. The another indication is configured to indicate the quality of the radio channel as estimated by the wireless device.

By the wireless device obtaining the first indication from the network node, the wireless device may be enabled to estimate the quality of the radio channel between the wireless device and the network node in the absence of an active connection to the network node and prior to the wireless device receiving data from the network node.

By the wireless device estimating the quality of the radio channel based on the obtained first indication and still in the absence of the active connection to the network node, the wireless device may be enabled to then report the estimate of the quality of the radio channel to the network node and prior to the wireless device receiving data from the network node.

By the wireless device sending the another indication indicating the estimated quality of the radio channel to the network node still in the absence of the active connection to the network node, the wireless device may enable the network node to ultimately use this information to assess whether to send the data during the random access procedure in the absence of an active connection to the wireless device, e.g., to either proceed with the MT-SDT procedure and perform link adaptation of the downlink data, or whether to send the data after having established an active connection to the wireless device, e.g., move the wireless device to RRC_CONNECTED and send the data to the wireless device there. Instead of a UE-centric solution using a rough indication of quality, such as RSRP, the wireless device may be enabled to provide a DL radio link quality report to the network node, which may be used for a better network (NW)-centric solution, both to determine if the MT-SDT procedure may be suitable, and for link adaptation of the DL data transmission. This may be understood to enable the network node to: a) only serve the wireless device data in RRC_INACTIVE if it may have a fair chance of succeeding with MT-SDT procedures, and b) use appropriate channel coding, e.g., link adaptation, depending on the current radio conditions with the chance of: i) fitting more data to the wireless device if channel conditions are appropriate, and ii) moving the wireless device to RRC_CONNECTED if it is expected to be better from a network usage, and end user performance perspective.

### BRIEF DESCRIPTION OF THE DRAWINGS

Examples of embodiments herein are described in more detail with reference to the accompanying drawings, according to the following description.

FIG. 1 is a schematic diagram depicting an example of a wireless communications network, according to embodiments herein.

FIG. 2 is a flowchart depicting a method in a wireless device, according to embodiments herein.

FIG. 3 is a flowchart depicting a method in a network node, according to embodiments herein.

FIG. 4 is a schematic diagram illustrating a non-limiting example of methods disclosed herein, according to some examples.

FIG. 5 is a schematic diagram illustrating a non-limiting example of aspects of methods disclosed herein, according to some examples.

FIG. 6 is a schematic block diagram illustrating two embodiments, in panel a) and panel b), of a wireless device, according to embodiments herein.

FIG. 7 is a schematic block diagram illustrating two embodiments, in panel a) and panel b), of a network node, according to embodiments herein.

FIG. 8 is a schematic block diagram illustrating an example of a communication system 800 in accordance with some embodiments.

FIG. 9 is a schematic block diagram illustrating a host 900, which may be an embodiment of the host 816 of FIG. 8, in accordance with various aspects described herein.

FIG. 10 shows a communication diagram of a host 1002 communicating via a network node 1004 with a UE 1006 over a partially wireless connection in accordance with some embodiments.

### DETAILED DESCRIPTION

Certain aspects of the present disclosure and their embodiments may provide solutions to the challenges described in the Summary section or other challenges. Embodiments herein may be generally understood relate to a quality indication for MT-SDT in Msg3. Particularly, some embodiments herein may relate to an approach that may enable the network to implicitly indicate to the UE that it may have to perform a radio link quality check on the Random Access Response, e.g., Msg2, and report it back to the network as part of Msg3. The network may then use this information to either proceed with the MT-SDT procedure and perform link adaptation of the downlink data, or move the UE to RRC_CONNECTED and serve the UE there, if needed.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

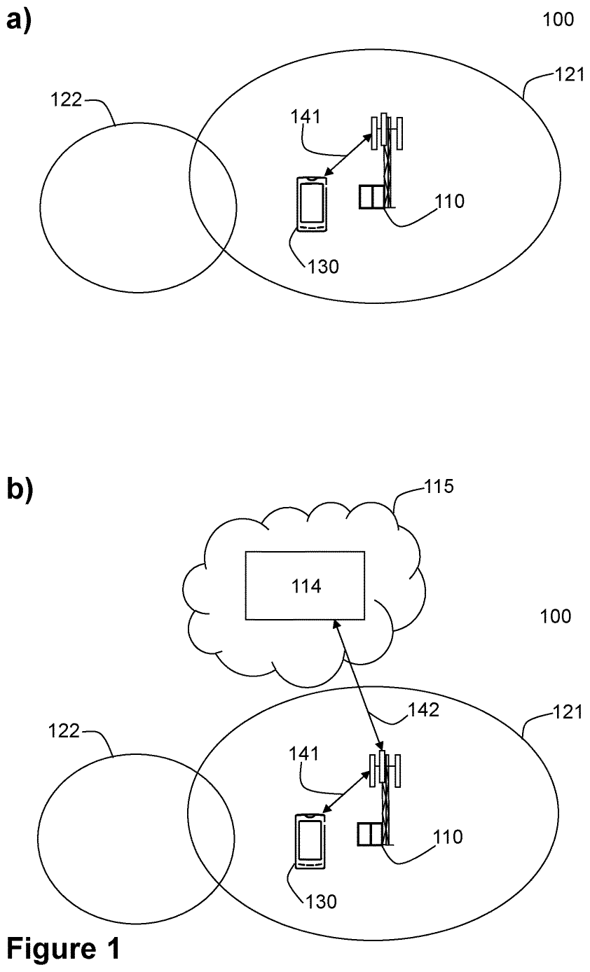

FIG. 1 depicts two non-limiting examples, in panel a) and panel b), respectively, of a wireless network or wireless communications network 100, sometimes also referred to as a wireless communications system, cellular radio system, or cellular network, in which embodiments herein may be implemented. The wireless communications network 100 may be a 5G system, 5G network, or Next Gen System or network. In other examples, the wireless communications network 100 may in addition, support other technologies such as, for example, Long-Term Evolution (LTE), e.g. LTE-M, LTE Frequency Division Duplex (FDD), LTE Time Division Duplex (TDD), LTE Half-Duplex Frequency Division Duplex (HD-FDD), LTE operating in an unlicensed band, such as LTE Licensed-Assisted Access (LAA), enhanced eLAA (eLAA), further enhanced LAA (feLAA) and/or MulteFire. Yet in other examples, the wireless communications network 100 may further support other technologies such as, for example Wideband Code Division Multiple Access (WCDMA), Universal Terrestrial Radio Access (UTRA) TDD, Global System for Mobile communications (GSM) network, GSM/Enhanced Data Rates for GSM Evolution (EDGE) Radio Access Network (GERAN) network, Ultra-Mobile Broadband (UMB), EDGE network, network comprising any combination of Radio Access Technologies (RATs) such as e.g., Multi-Standard Radio (MSR) base stations, multi-RAT base stations etc., any 3rd Generation Partnership Project (3GPP) cellular network, WiFi networks, Worldwide Interoperability for Microwave Access (WiMax), or any cellular network or system. The wireless communications network 100 may typically support MTC, eMTC, IoT and/or NB-IoT. Thus, although terminology from 5G/NR and LTE may be used in this disclosure to exemplify embodiments herein, this should not be seen as limiting the scope of the embodiments herein to only the aforementioned system.

The wireless communications network 100 may comprise a plurality of network nodes, whereof a network node 110 is depicted in the non-limiting example of FIG. 1. The network node 110 is a radio network node. That is, a transmission point such as a radio base station, for example a gNB, or any other network node with similar features capable of serving a user equipment, such as a wireless device or a machine type communication device, in the wireless communications network 100. In some examples, such as that depicted in FIG. 1b, the network node 110 may be a distributed node, and may partially perform its functions in collaboration with a virtual node 114 in a cloud 115. The network node 110 may be directly connected to one or more core networks, e.g., to one or more network nodes in the one or more core networks.

The wireless communications network 100 may cover a geographical area, which in some embodiments may be divided into cell areas, wherein each cell area may be served by a radio network node, although, one radio network node may serve one or several cells. In the example of FIG. 1, the network node 110 serves a first cell 121 and a second cell 122. In other embodiments not depicted in FIG. 1, the second cell 122 may be served by another network node. The network node 110 may be of different classes, such as, e.g., macro base station, home base station or pico base station, based on transmission power and thereby also cell size. In some examples, the network node 110 may serve receiving nodes with serving beams. The network node 100 may support one or several communication technologies, and its name may depend on the technology and terminology used.

A plurality of wireless devices may be located in the wireless communication network 100, whereof a wireless device 130, is depicted in the non-limiting example of FIG. 1. The wireless device 130 comprised in the wireless communications network 100 may be a wireless communication device such as a 5G User Equipment (UE) or nUE, or a UE, which may also be known as e.g., mobile terminal, wireless terminal and/or mobile station, a mobile telephone, cellular telephone, or laptop with wireless capability, just to mention some further examples. The wireless device 130 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, a sensor, IoT device, NB-IoT device, device equipped with a wireless interface, such as a printer or a file storage device, modem, or any other radio network unit capable of communicating over a radio link in a communications system. The wireless device 130 comprised in the wireless communications network 100 may be enabled to communicate wirelessly in the wireless communications network 100. The communication may be performed e.g., via a RAN, and possibly the one or more core networks, which may be comprised within the wireless communications network 100.

The wireless device 130 may be configured to communicate within the wireless communications network 100 with the network node 110 over a first link 141, e.g., a radio link. The network node 110 may be configured to communicate within the wireless communications network 100 with the virtual network node 114 over a second link 142, e.g., a radio link or a wired link.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In general, the usage of “first”, “second”, “third”, “fourth” and/or “fifth” herein may be understood to be an arbitrary way to denote different elements or entities, and may be understood to not confer a cumulative or chronological character to the nouns they modify, unless otherwise noted, based on context.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

More specifically, the following are embodiments related to a wireless device, such as the wireless device 130, e.g., a 5G UE, nUE or a UE, and embodiments related to a network node, such as the network node 110, e.g., a gNB.

Some embodiments herein will now be further described with some non-limiting examples, which may be combined with the embodiments just described.

In the following description, any reference to a/the UE, or simply “UE” may be understood to equally refer the wireless device 130; any reference to a/the gNB and/or a/the network may be understood to equally refer to the network node 110; any reference to a/the “cell” may be understood to equally refer to the first cell 121.

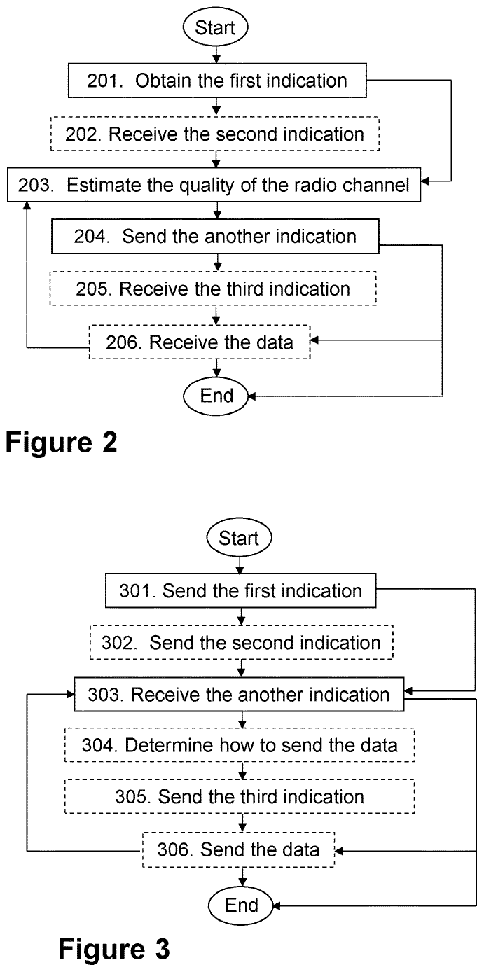

Embodiments of a method, performed by a wireless device, such as the wireless device 130, will now be described with reference to the flowchart depicted in FIG. 2. The method may be understood to be for handling absence of an active connection to the network node 110. The wireless device 130 and the network node 110 operate in a wireless communications network, such as the wireless communications network 100. The method may be understood to be computer-implemented.

In some embodiments, the wireless communications network 100 may support new radio (NR).

Several embodiments are comprised herein. The method may comprise three or more of the following actions. In some embodiments, all the actions may be performed. It should be noted that the examples herein may be not mutually exclusive. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the wireless device 130 is depicted in FIG. 2. In FIG. 2 optional actions in some embodiments may be represented with dashed lines. In some embodiments, the actions may be performed in a different order than that depicted FIG. 2.

### Action 201

In this Action 201, the wireless device 130 obtains a first indication from the network node 110.

The first indication indicates that the wireless device 130 is to perform an estimation of a quality of a radio channel between the wireless device 130 and the network node 110.

The estimation is to be performed during the random access procedure in the absence of an active connection to the network node 110, and prior to the wireless device 130 receiving data from the network node 110. The data may be small data, e.g., an SDT. That is, a MT-SDT. Small data may be understood, for example, as data wherein a size of a buffer of the network node 110 for the downlink transmission of the data is smaller than a threshold.

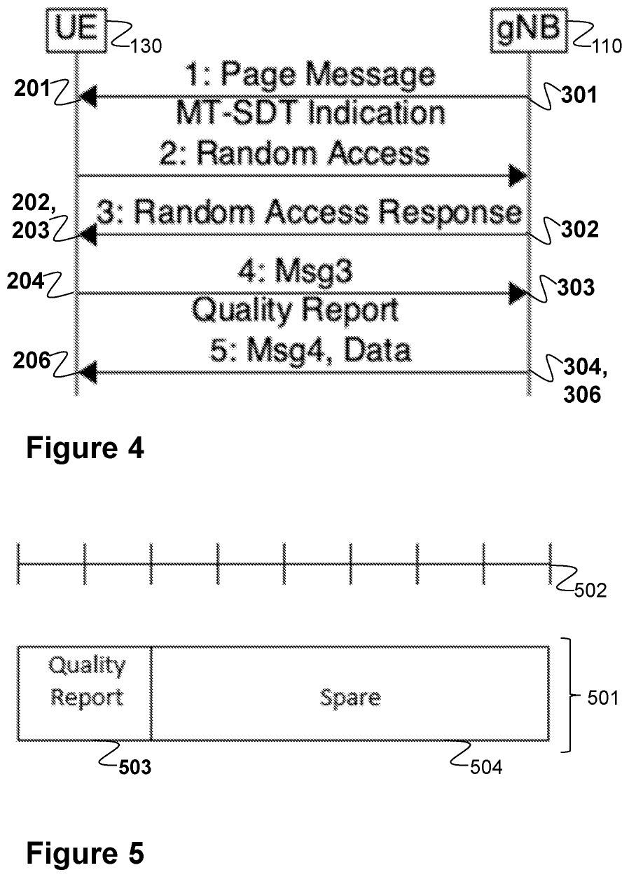

In embodiments herein, during the random access procedure may comprise, as depicted later in the non-limiting example of FIG. 4, from the receipt of a paging message from the network node 110, which paging message may be understood to trigger the wireless device 130 to transmit a preamble to the network node 110. In other words, in some examples of embodiments herein, “during the random access procedure” may comprise during a random access procedure initiated by the wireless device 130 or a paging procedure triggering it. In other examples, during the random access procedure may comprise from transmission of the preamble by the wireless device 130.

In some embodiments, the first indication may be one of the following: a) implicitly indicated, e.g., in a random access response message received from the network node 110, b) explicitly indicated, e.g., in a paging message, and c) broadcasted in a cell, such as the first cell 121 served by the network node 110, wherein the wireless device 130 may be located.

In some embodiments, one of the following may apply: a) the first indication may be implicitly indicated in a paging message received from the network node 110, e.g., as indicated by a presence of a Mobile Terminated Small Data Transmission (MT-SDT) indication in the paging message, b) the first indication may be explicitly indicated by at least one of: an explicit indication in the paging message, and one or more preambles, e.g., one or more dedicated preambles, and c) the first indication may be broadcasted in system information (SI).

In some embodiments, the first indication may be comprised in a random access response in the random access procedure with the network node 110. In a first example, the wireless device 130 may be implicitly instructed, e.g., by the first indication, to perform radio channel quality estimation on Msg2, that is a Random Access Response (RAR), as decided by the presence of an MT-SDT indication in the paging message, e.g., see 1 in FIG. 4, or as configured in SI for the cell, e.g., the first cell 121. In another option of this example, the wireless device 130 may only perform measurements of radio channel quality measurements if explicitly instructed, e.g., by the first indication, in the paging message. This may be in the form of an indication in the paging message or by receiving one or several dedicated preambles in the paging message or both.

By the wireless device 130 obtaining the first indication from the network node 110 in this Action 201, the wireless device 130 may be enabled to estimate the quality of the radio channel between the wireless device 130 and the network node 110 in the absence of an active connection to the network node 110 and prior to the wireless device 130 receiving data from the network node thereby enabling the network 110 to ultimately use this information to assess whether to send the data during the random access procedure in the absence of an active connection to the wireless device 130, e.g., to either proceed with the MT-SDT procedure and perform link adaptation of the downlink data, or whether to send the data after having established an active connection to the wireless device 130, e.g., move the wireless device 130 to RRC_CONNECTED and send the data to the wireless device 130 there. Instead of a UE-centric solution using a rough indication of quality, such as RSRP, the wireless device 130 may be enabled to provide a DL radio link quality report to the network node 110, which may used for a better network (NW)-centric solution, both to determine if the MT-SDT procedure may be suitable, and for link adaptation of the DL data transmission. This may be understood to enable the network node 110 to: a) only serve the wireless device 130 data in RRC_INACTIVE if it may have a fair chance of succeeding with MT-SDT procedures, and b) use appropriate channel coding, e.g., link adaptation, depending on the current radio conditions with the chance of: i) fitting more data to the wireless device 130 if channel conditions are appropriate, and ii) moving the wireless device 130 to RRC_CONNECTED if it is expected to be better from a network usage, and end user performance perspective.

### Action 202

In this Action 202, the wireless device 130 may receive a second indication. The receiving in this Action 202 may be from the network node 110.

The receiving in this Action 202 may be performed, e.g., via the first link 141.

The second indication may comprise a first uplink grant. The first uplink grant may be, e.g., an Msg3 grant.

In some embodiments, the first uplink grant may have a larger size than a second uplink grant, e.g., to accommodate for a channel quality report.

In some embodiments, one of the following three options may apply.

According to a first option, the second indication may be received after having received the first indication from the network node 110, and the second uplink grant may be to be received in another random access procedure wherein the first indication is absent. In other words, the wireless device 130 may only receive the larger uplink grant when it may have been triggered to perform the estimation of the quality of the radio channel between the wireless device 130 and the network node 110, and the network node 110 may know the wireless device 130 may need to report the estimation back to the network node 110, and not otherwise. That is, if the wireless device 130 may not have been triggered to perform the estimation of the quality of the radio channel between the wireless device 130 and the network node 110, the wireless device 130 may an uplink grant of a legacy size such as the second uplink grant.

According to a second option, the second indication may be received based on a presence of the wireless device 130 in the first cell 121 served by the network node 110. The first cell 121 may support an MT-SDT procedure. The second uplink grant may be to be received in a second cell. The second cell 122 may lack support for the MT-SDT procedure.

According to a third option, the second indication may be received with the proviso the wireless device 130 may have received a first preamble, e.g., CFRA preamble, of one or more dedicated preambles from the network node 110, and sent the first preamble back to the network node 110. The second indication may not be received with the proviso the wireless device 130 may not have received the first preamble or not sent the preamble back to the network node 110. The second uplink grant may be to be received in the absence of having received the first preamble.

In a second example, e.g., in accordance with the first option, the network node 110 may allocate a slightly larger Msg3 UL grant size in all RAR messages for a limited time when it may have sent, e.g., in Action 301, an MT-SDT paging indication to one UE. This may be understood to be because the actual cause for the following random access procedure, or which wireless device 130 it may be from, may not be known until Msg3, so the network node 110 may not be able to be aware of which random access may belong to a certain page until Msg3, where a Resume cause may be provided from the wireless device 130 to the network node 110. Based on the Msg3, the contention resolution procedure may be done at the network node 110 side, which may also make the network know about the capabilities of the UEs. The reason for the larger Msg3 UL grant size may be simply because the regular grant may be matched to fit the legacy RRC Resume message, and therefore a somewhat larger grant may be needed to fit the DL quality report in addition to the RRCResume message. The time to send, e.g., in Action 302, the larger grants may be based on either a fixed time or when the paged wireless device 130 may have made a random access, or a combination of both options. The fixed time may depend on the configuration, e.g., the periodicity of the RA occasions, e.g., prach-ConfigurationIndex, the maximum number of retransmissions allowed, e.g., preambleTransMax, the length of the RAR window, e.g., ra-ResponseWindow, or other configurable parameters.

In one alternative of the above, in accordance with the second option, the network node 110 may always provide, e.g., as will be described later in Action 302, somewhat larger Msg3 UL grant size, to fit the DL quality report, to all UEs whenever MT-SDT may be configured and supported in the first cell 121.

In another alternative, in accordance with the third option, if a Contention Free Random Access (CFRA) preamble may be provided to the wireless device 130 in a paging message as part of MT-SDT, the network node 110 may allocate a larger Msg3 UL grant size, to fit the DL quality report, only as a response to this preamble, that is, this wireless device 130, and not to other preambles. In one option, the preamble may be reserved for a configurable time. In another option, the CFRA preamble may be reserved for the wireless device 130 during the entire MT-SDT procedure, and may be used e.g., to obtain a grant in case the wireless device 130 may receive UL data during the ongoing MT-SDT procedure.

In some embodiments, the first uplink grant may have a same size than the second uplink grant to be received in another random access procedure wherein the first indication may be absent. In another version of the second example, the grant size in the RAR message may be of legacy size and no quality report may be included in Msg3. Instead, when Msg3 may be received, the network node 110 may issue a new grant for the quality report when it may have been identified that the wireless device 130 is responding to the paging for MT-SDT. In another aspect of this example, the wireless device 130 may continue to do quality measurements, e.g., as will be described in Action 203, during the entire MT-SDT procedure. The quality may then be reported to the network node 110, e.g., in Action 204. In one example, the quality reports may only be sent to the network node 110 if the network node 110 gives a grant to the wireless device 130, e.g., as will be described in Action 302, that is, the quality reports may not trigger a Scheduling Request (SR) or RA procedure to obtain a grant.

In some embodiments, at least one of the following may apply: a) as stated earlier, the first indication may be comprised in a random access response in the random access procedure with the network node 110, and b) the first indication may be comprised in the random access response and may be the first uplink grant.

### Action 203

In some embodiments, in this Action 203, the wireless device 130 estimates the quality of the radio channel.

The estimating of the quality of the radio channel in this Action 203 is based on the obtained first indication. Based on the obtained first indication may be understood to mean triggered by the first indication.

The estimating of the quality of the radio channel in this Action 203 is based on the obtained first indication and still in the absence of the active connection to the network node 110.

The estimating of the quality of the radio channel in this Action 203 may be performed on: a) the random access response message, e.g., received from the network node 110 during the random access procedure, for example, on Msg2, and/or b) a paging message received from the network node 110, e.g., during the random access procedure. The random access procedure may be a 2 step or a 4 step random access procedure. The paging message may be, e.g., a paging message on the Paging CHannel (PCH).

In an example, the wireless device 130 may base the DL quality measurement, e.g., according to Action 203, on the paging reception, that is, paging message on Physical Downlink Shared CHannel (PDSCH), instead of or in addition to the RAR reception.

The estimation of the quality of the radio channel may be performed by e.g., measuring a demodulation reference signal (DMRS) associated to the PDSCH transmission.

By the wireless device 130 estimating the quality of the radio channel based on the obtained first indication and still in the absence of the active connection to the network node 110 in this Action 203, the wireless device 130 may be enabled to then report the estimate of the quality of the radio channel to the network node 110 and prior to the wireless device 130 receiving data from the network node thereby enabling the network 110 to ultimately use this information to assess whether to send the data during the random access procedure in the absence of an active connection to the wireless device 130, e.g., to either proceed with the MT-SDT procedure and perform link adaptation of the downlink data, or whether to send the data after having established an active connection to the wireless device 130, e.g., move the wireless device 130 to RRC_CONNECTED and send the data to the wireless device 130 there, enabling to achieve the benefits explained in relation to Action 201.

### Action 204

In this Action 204, the wireless device 130 sends another indication to the network node 110.

The sending in this Action 204 may be, e.g., transmitting, and may be performed, e.g., via the first link 141.

The another indication indicates the estimated quality of the radio channel. The another indication may be, e.g., a DL quality report.

The sending in this Action 204 of the another indication is based on the obtained first indication.

The sending in this Action 204 of the another indication is based on the obtained first indication and still in the absence of the active connection to the network node 110.

In some embodiments, the wireless device 130 may send the another indication in resources indicated in the received first uplink grant.

In some embodiments, the first uplink grant may have a same size than the second uplink grant to be received in another random access procedure wherein the first indication may be absent. The first uplink grant may be received, by the wireless device 130, after the wireless device 130 may have sent a subsequent message to a random access response from the network node 110, and the first uplink grant may be received to send the another indication.

In some embodiments, at least one of the following may apply: a) the another indication may be indicated by the first preamble sent by the wireless device 130 to the network node 110, b) the first preamble may be one of a plurality of preambles reserved for the wireless device 130, and c) the another indication may be sent in a subsequent message to the random access response from the network node 110.

In some embodiments, the another indication may be sent as one of: i) an information element in an RRC message, and ii) a Medium Access Control (MAC) control element.

In a third example, the wireless device 130 may send, e.g., according to this Action 204, the result of the quality estimation as part of Msg3, with the extended grant, in the form of an information element in the RRC message, alternatively in the form of a MAC control element, see FIG. 5. The report may indicate to the network node 110 on the actual quality of the downlink channel, in a granularity that may be appropriate for a small data quality report. That is, the quality report may be adjusted to the maximum transport block size that may be supported by MT-SDT transmission. For example, it may be pointless to report better channel quality when the largest possible Transport Block Size (TBS) may have been reached.

In a fourth example, the network node 100 may send, e.g., according to Action 306 and Action 206 described later, downlink data to the wireless device 130, in a channel coding and modulation scheme, and resource allocation, that may best fit the radio channel quality reported by the wireless device 130 in this Action 204.

In an alternative of any the above, the wireless device 130 may base the DL quality measurement, e.g., according to Action 203, on the paging reception, that is, paging message on Physical Downlink Shared CHannel (PDSCH), instead of or in addition to the RAR reception. In one alternative of the former case, where the quality indication calculation may be performed, e.g., according to Action 203, using paging reception instead of RAR reception, the quality indication may be conveyed, e.g., according to this Action 204, by the wireless device 130 by manipulating the choice of preamble accordingly, instead of sending the Quality Indication as part of Msg3. This manipulation may be in the order of choosing the preamble, or the preamble itself, and may be different based on the implementation. For example, if multiple CFRA preambles, each one corresponding to a quality indication, may be provided as part of paging message, the wireless device 130 may choose the preamble that may suit the appropriate quality measurement.

In one example, only one preamble may be indicated in the paging message, but several preambles may be reserved for the wireless device 130. This may be understood to be to limit the number of CFRA preambles that may need to be indicated in the paging message to allow the wireless device 130 to be able to indicate the preferable Synchronization Signal Block (SSB) with the preamble transmission. In one example, if e.g., CFRA preamble index 10 may be indicated in the paging message and the SSB configuration may be 4 SSBs per RACH occasion (RO), 4 consecutive preamble indices may be configured starting from the indicated preamble, e.g., preamble 10. Therefore, only preamble index 10 may be indicated in the paging message but preamble index 10-13 may all be reserved as dedicated preambles for the wireless device 130. This may be understood to mean that if e.g., SSB1-SSB4 are mapped to a RO, preamble 10 may indicate SSB1, preamble 11 may indicate SSB2, preamble 13 may indicate SSB3 and preamble 14 may indicate SSB4 for a preamble transmission in this RO.

By the wireless device 130 sending the another indication to the network node 110 still in the absence of the active connection to the network node 110 in this Action 204, the wireless device 130 may enable the network node 110 to use this information to assess whether to send the data during the random access procedure in the absence of an active connection to the wireless device 130, e.g., to either proceed with the MT-SDT procedure and perform link adaptation of the downlink data, or whether to send the data after having established an active connection to the wireless device 130, e.g., move the wireless device 130 to RRC_CONNECTED and send the data to the wireless device 130 there, enabling to achieve the benefits explained in relation to Action 201.

### Action 205

In this Action 205, the wireless device 130 may receive a third indication.

The receiving in this Action 205 may be from the network node 110.

The receiving in this Action 205 may be performed, e.g., via the first link 141.

The third indication may indicate that the wireless device 130 may have to establish a connection with the network node 110, e.g., is to switch RRC Connected state.

The third indication may be based on the indicated estimated quality of the radio channel.

In a fifth example, the network node 110 may bring the wireless device 130 to RRC_CONNECTED mode, if the channel quality report in Msg3 indicates that the wireless device 130 may be better served in RRC_CONNECTED state by the network node 100 instead of using MT-SDT in RRC_INACTIVE. This decision, e.g., performed according to Action 304, may also be based on both the quality report and the amount of DL data available for the wireless device 130, enabling to achieve the benefits explained in relation to Action 201.

### Action 206

In this Action 206, the wireless device 130 may receive data.

The receiving in this Action 206 may be from the network node 110.

The receiving in this Action 206 may be performed, e.g., via the first link 141.

In some embodiments, one of the following may apply: i) in the absence of having received the third indication, the data may be received using a channel coding and modulation scheme, and/or resource allocation based on the indicated estimated quality of the radio channel, and ii) the data may be received after having established the connection with the network node 110, e.g., in RRC connected state.

By, in this Action 206, receiving the data from the network node 110 in Action 206, based on having received or not the third indication, and thereby based on the estimated quality of the radio channel, the wireless device 130 may be understood to enable to achieve the benefits described above for Action 201.

Embodiments of a method, performed by a network node, such as the network node 110 will now be described with reference to the flowchart depicted in FIG. 3. The method may be understood to be for handling the absence of an active connection to the wireless device 130. The network node 110 and the wireless device 130 operate in a wireless communications network, such as the wireless communications network 100. The method may be understood to be computer-implemented.

In some embodiments, the wireless communications network 100 may support new radio (NR).

The method may comprise one or more of the following actions. In some embodiments, all the actions may be performed. It should be noted that the examples herein may be not mutually exclusive. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the network node 110 is depicted in FIG. 3. In FIG. 3, optional actions in some embodiments may be represented with dashed lines. In some embodiments, the actions may be performed in a different order than that depicted FIG. 3. The detailed description of some of the following corresponds to the same references provided above, in relation to the actions described for the wireless device 130 and will thus not be repeated here to simplify the description. For example, the active connection to the wireless device 130 may be an RRC Connected mode.

### Action 301

In this Action 301, the network node 110 sends the first indication to the wireless device 130.

The sending in this Action 301 may be performed, e.g., via the first link 141.

The first indication indicates that the wireless device 130 is to perform the estimation of the quality of the radio channel between the wireless device 130 and the network node 110.

The estimation is to be performed during the random access procedure in the absence of an active connection to the wireless device 130.

The estimation is to be performed during the random access procedure in the absence of an active connection to the wireless device 130, and prior to the wireless device 130 receiving data from the network node 110.

In some embodiments, the first indication may be one of: a) implicitly indicated, e.g., in the random access response message sent by the network node 110, b) explicitly indicated, e.g., in the paging message, and c) broadcasted in a cell, such as the first cell 121, served by the network node 110, wherein the wireless device 130 may be located.

### Action 302

In this Action 302, network node 110 may send the second indication to the wireless device 130.

The sending in this Action 302 may be performed, e.g., via the first link 141.

The second indication may comprise the first uplink grant.

In some embodiments, the first uplink grant may have a larger size than the second uplink grant. In some embodiments, one of the following options may apply. According to a first option, the second indication may be sent after having sent the first indication to the wireless device 130, and the second uplink grant may be to be sent in the another random access procedure wherein the first indication may be absent. According to a second option, the second indication may be sent based on the presence of the wireless device 130 in the first cell 121 served by the network node 110. The first cell 121 may support the MT-SDT procedure. The second uplink grant may be to be sent in the second cell, e.g., the second cell 122, lacking support for the MT-SDT procedure. According to a third option, the second indication may be sent with the proviso the network node 110 may have sent the first preamble, e.g., CFRA preamble, of the one or more dedicated preambles for the wireless device 130, and received the first preamble back from the wireless device 130. The second indication may not be sent with the proviso the network node 110 may not have sent the first preamble or not received the preamble back from the wireless device 130. The second uplink grant may be to be sent in the absence of having received and/or sent the first preamble.

In some embodiments, the first uplink grant may have the same size than the second uplink grant to be sent in the another random access procedure wherein the first indication may be absent. The first uplink grant may be sent, by the network node 110, after the network node 110 may have received, from the wireless device 130, the subsequent message to the random access response from the network node 110, and the first uplink grant may be sent for the wireless device 130 to send the another indication.

In some embodiments, at least one of the following may apply: a) the first indication may be comprised in the random access response in the random access procedure with the wireless device 130, and b) the first indication may be comprised in the random access response and may be the first uplink grant.

### Action 303

In this Action 303, the network node 110 receives the another indication from the wireless device 130.

The receiving in this Action 303 may be performed, e.g., via the first link 141.

The another indication indicates the quality of the radio channel as estimated by the wireless device 130.

The receiving in this action 303 of the another indication is based on the sent first indication.

The receiving in this Action 303 of the another indication is based on the sent first indication and still in the absence of the active connection to the wireless device 130.

In some embodiments, one of the following may apply: a) the first indication may be implicitly indicated in the paging message sent by the network node 110, e.g., as indicated by the presence of the MT-SDT indication in the paging message, b) the first indication may be explicitly indicated, by at least one of: the explicit indication in the paging message, and the one or more preambles, e.g., the one or more dedicated preambles, and c) the first indication may be broadcasted in system information.

In some embodiments, the another indication may be received from the wireless device 130 in resources indicated in the sent first uplink grant.

In some embodiments, at least one of the following may apply: a) the another indication may be indicated by the first preamble received from the wireless device 130 by the network node 110, b) the first preamble may be one of a plurality of preambles reserved for the wireless device 130, and c) the another indication may be received in the subsequent message to the random access response from the network node 110.

In some embodiments, the another indication may be received as one of: the information element in the RRC message, and the MAC control element.

### Action 304

In this Action 304, the network node 110 may determine how to send the data to the wireless device 130.

Determining may be understood as deciding, selecting, or similar.

The determining in this Action 304 may be based on the indicated estimated quality of the radio channel.

The determining in this Action 304 of how to send the data to the wireless device 130 may comprise determining e.g., whether to send the data during the random access procedure in the absence of an active connection to the wireless device 130 or after having established an active connection to the wireless device 130, e.g., in RRC connected state.

### Action 305

In this action 305, the network node 110 may send the third indication to the wireless device 130.

The sending in this Action 305 may be performed, e.g., via the first link 141.

The third indication may indicate that the wireless device 130 may have to establish a connection with the network node 110, e.g., is to switch RRC Connected state.

The sending in this Action 305 may be based on the indicated estimated quality of the radio channel.

### Action 306

In this Action 306, the network node 110 may send the data to the wireless device 130.

The sending in this Action 306 may be performed, e.g., via the first link 141, one of: i) in the absence of having sent the third indication, the data may be sent using the channel coding and modulation scheme, and/or resource allocation based on the indicated estimated quality of the radio channel, and ii) the data may be sent after having established the connection with the wireless device 130, e.g., in RRC connected state.

In some examples, the network node 110 may perform link adaptation based on the received another indication. The network node 110 may perform the link adaptation after receiving the another indication and before sending the data in this Action 306.

As stated earlier, in a fourth example, the network node 100 may send, e.g., according to this Action 306, downlink data to the wireless device 130, in a channel coding and modulation scheme, and resource allocation, that may best fit the radio channel quality reported by the wireless device 130 in Action 204.

FIG. 4 is a schematic diagram depicting a non-limiting example of a signaling overview according to embodiments herein. In this particular non-limiting example of embodiments herein, the wireless device 130 is a UE and the network node 110 is a gNB. At 1, in accordance with Action 301 and Action 201, the network node 110 sends a page message to the wireless device 130 implicitly indicating the first indication by the presence of the MT-SDT indication. At 2, the wireless device 130 sends a RA preamble to the network node 110. At 3, in accordance with Action 302 and Action 202, the network node 100 sends a RAR to the wireless device 130 as the second indication comprising the first uplink grant. In accordance with Action 303, the wireless device 130 estimates the quality of the radio channel with the network node 110. At 4, in accordance with Action 204 and Action 303, the wireless device 130 sends an Msg3 the network node 110 comprising the another indication to as indicating the estimated quality of the radio channel. At 5, in accordance with Action 304, the network node 110 determines that the quality of the channel is sufficient to send the data to the wireless device 130 during the random access procedure in the absence of an active connection to the wireless device 130, and in accordance with Action 306, the network node 110 sends a Msg4 to the wireless device 130 comprising the data.

FIG. 5 is a schematic diagram depicting a non-limiting example of a MAC CE 501. Particularly, the MAC CE 501 depicted in FIG. 5 is the another indication comprising the quality report 502 sent by the wireless device 130 to the network node 100 according to Action 204 and Action 303. The MAC CE 501 depicted in FIG. 5 is of one octet 503, wherein the first two bits are occupied by the quality report 502, and the remaining six bits 504 are spare.

As a summarized overview of the foregoing, embodiments herein may extend the MT-SDT procedure to include a radio channel quality estimation by the wireless device 130 for MT-SDT indicated paging.

The wireless device 130 may report the channel estimation back to the network node 110 as part of the Msg3.

The network node 110 may perform link adaptation on the mobile terminated data either in RRC_INACTIVE (MT-SDT) or in RRC_CONNECTED.

Embodiments herein may impact the technical specifications in the following aspects. One aspect relates to paging procedures, particularly, the inclusion of a possible quality report indication, or the implicit use of quality reporting in msg3 based on MT-SDT paging indication.

Another aspect relates to measuring of quality by the wireless device 130. The wireless device 130 may need to measure the quality on Msg2 and/or the paging message.

Another aspect relates to reporting of quality. The wireless device 130 may need to include the report in RRC message and/or a MAC CE.

Yet another aspect relates to a decision by the network node 110. The network node 110 may need to serve the wireless device 130 based on the quality report, either link adapted in RRC_INACTIVE, or in RRC_CONNECTED.

Certain embodiments disclosed herein may provide one or more of the following technical advantage(s), which may be summarized as follows.

Instead of a UE-centric solution using a rough indication of quality, such as RSRP, embodiments herein, may be understood to enable a UE such as the wireless device 130 to provide a DL radio link quality report to the network, e.g., the network node 110, which may used for a better network (NW)-centric solution, both to determine if the MT-SDT procedure may be suitable, and for link adaptation of the DL data transmission. This may be understood to enable the network node 110 to: a) only serve the wireless device 130 data in RRC_INACTIVE if it may have a fair chance of succeeding with MT-SDT procedures, and b) use appropriate channel coding, e.g., link adaptation, depending on the current radio conditions with the chance of: i) fitting more data to the wireless device 130 if channel conditions are appropriate, and ii) moving the wireless device 130 to RRC_CONNECTED if it is expected to be better from a network usage, and end user performance perspective.

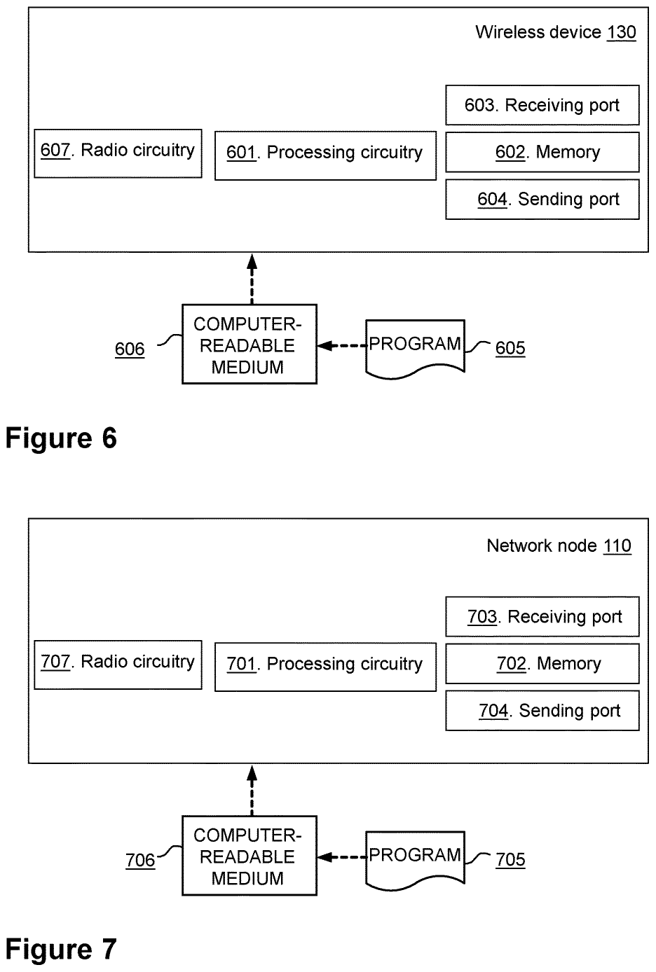

FIG. 6 depicts an example of the arrangement that the wireless device 130 may comprise to perform the method actions described above in relation to FIG. 2. The wireless device 130 may be understood to be for handling the absence of the active connection to the network node 110. The wireless device 130 and the network node 110 may be configured to operate in the wireless communications network 100.

In some embodiments, the wireless communications network 100 may be configured to support NR.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the wireless device 130 and will thus not be repeated here. For example, the connected mode may be an RRC connected mode.

The wireless device 130 is configured and/or operable to perform the obtaining in Action 201, e.g. by means of a processing circuitry 601 within the wireless device 130 configured to, obtain the first indication from the network node 110. The first indication is configured to indicate that the wireless device 130 is to perform the estimation of the quality of the radio channel between the wireless device 130 and the network node 110. The estimation is configured to be performed during a random access procedure in the absence of an active connection to the network node 110 and prior to the wireless device 130 receiving data from the network node 110.

The wireless device 130 is also configured and/or operable to perform the estimating in Action 203, e.g. by means of the processing circuitry 601 within the wireless device 130 configured to, estimate, based on the first indication configured to be obtained and still in the absence of the active connection to the network node 110, the quality of the radio channel.

The wireless device 130 is configured and/or operable to perform the sending in Action 204, e.g. by means of the processing circuitry 601 within the wireless device 130 configured to, send, based on the first indication configured to be obtained and still in the absence of the active connection to the network node 110, the another indication to the network node 110. The another indication is configured to indicate the quality of the radio channel configured to be estimated.

In some embodiments, the first indication may be configured to be one of: a) implicitly indicated, b) explicitly indicated, and c) broadcasted in the first cell 121 configured to be served by the network node 110, wherein the wireless device 130 may be configured to be located.

In some embodiments, one of may apply: a) the first indication may be configured to be implicitly indicated in the paging message configured to be received from the network node 110, b) the first indication may be configured to be explicitly indicated by at least one of: the explicit indication in the paging message, and the one or more dedicated preambles, and c) the first indication may be configured to be broadcasted in system information.

In some embodiments, the wireless device 130 may be further configured and/or operable to perform the receiving in Action 202, e.g. by means of the processing circuitry 601 within the wireless device 130 configured to, receive the second indication from the network node 110. The second indication may be configured to comprise the first uplink grant. The wireless device 130 may be configured to send the another indication in resources configured to be indicated in the first uplink grant configured to be received.

In some embodiments, the first uplink grant may be configured to have a larger size than the second uplink grant, and one of the following may apply: i) the second indication may be configured to be received after having received the first indication from the network node 110, and the second uplink grant may be configured to be received in another random access procedure wherein the first indication may be configured to be absent, ii) the second indication may be configured to be received based on the presence of the wireless device 130 in the first cell 121 configured to be served by the network node 110, the first cell 121 being configured to support a Mobile Terminated Small Data Transmission procedure, and wherein the second uplink grant may be configured to be received in the second cell 122 configured to lack support for the Mobile Terminated Small Data Transmission procedure, and iii) the second indication may be configured to be received with the proviso the wireless device 130 may have received the first preamble, of one or more dedicated preambles from the network node 110, and sent the first preamble back to the network node 110, and the second indication may not be received with the proviso the wireless device 130 may not have received the first preamble or not sent the preamble back to the network node 110, and the second uplink grant may be configured to be received in the absence of having received the first preamble.

In some embodiments, at least one of the following may apply: a) the another indication may be configured to be indicated by the first preamble configured to be sent by the wireless device 130 to the network node 110, b) the first preamble may be configured to be one of the plurality of preambles reserved for the wireless device 130, and c) the another indication may be configured to be sent in a subsequent message to a random access response from the network node 110.

In some embodiments, the another indication may be configured to be sent as one of: i) the information element in the RRC message, and ii) the MAC control element.

In some embodiments, the first uplink grant may be configured to have the same size than the second uplink grant configured to be received in the another random access procedure wherein the first indication may be absent, and the first uplink grant may be received, by the wireless device 130, after the wireless device 130 may have sent the subsequent message to the random access response from the network node 110, and the first uplink grant may be configured to be received to send the another indication.

In some embodiments, one of the following may apply: a) the first indication may be configured to be comprised in the random access response in the random access procedure with the network node 110, and b) the first indication may be configured to be comprised in the random access response and may be the first uplink grant.

In some embodiments, the wireless device 130 may be configured with at least one of the following two configurations.

In some embodiments, the wireless device 130 may be configured and/or operable to perform the receiving in Action 205, e.g. by means of the processing circuitry 601 within the wireless device 130 configured to, receive the third indication from the network node 110 based on the estimated quality of the radio channel configured to be indicated. The third indication may be configured to indicate that the wireless device 130 may have to establish a connection with the network node 110.

In some embodiments, the wireless device 130 may be configured and/or operable to perform the receiving in Action 206, e.g. by means of the processing circuitry 601 within the wireless device 130 configured to, receive data from the network node 110. One of the following may apply: i) in the absence of having received the third indication, the data may be received using the channel coding and modulation scheme, and resource allocation configured to be based on the estimated quality of the radio channel configured to be indicated, and ii) the data may be configured to be received after having established the connection with the network node 110.

The embodiments herein in the wireless device 130 may be implemented through one or more processors, such as the processing circuitry 601 in the wireless device 130 depicted in FIG. 6a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the wireless device 130. One such carrier may be in the form of a CD ROM disc. It is however feasible with other data carriers such as a memory stick. The computer program code may furthermore be provided as pure program code on a server and downloaded to the wireless device 130.

The processing circuitry 601 may be configured to, or operable to, perform the method actions according to FIG. 2.

The wireless device 130 may further comprise a memory 602 comprising one or more memory units. The memory 602 is arranged to be used to store obtained information, store data, configurations, schedulings, and applications etc. to perform the methods herein when being executed in the wireless device 130.

In some embodiments, the wireless device 130 may receive information from, e.g., the network node 110 or another structure in the wireless communications network 100, through a receiving port 603. In some embodiments, the receiving port 603 may be, for example, connected to one or more antennas in wireless device 130. In other embodiments, the wireless device 130 may receive information from another structure in the wireless communications network 100 through the receiving port 603. Since the receiving port 603 may be in communication with the processing circuitry 601, the receiving port 603 may then send the received information to the processing circuitry 601. The receiving port 603 may also be configured to receive other information.

The processing circuitry 601 in the wireless device 130 may be further configured to transmit or send information to e.g., the network node 110 or another structure in the wireless communications network 100, through a sending port 604, which may be in communication with the processing circuitry 601, and the memory 602.

Those skilled in the art will also appreciate that the processing circuitry 601 described above may comprise a combination of analog and digital modules, and/or one or more processors configured with software and/or firmware, e.g., stored in memory, that, when executed by the one or more processors such as the processing circuitry 601, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the wireless device 130 may be configured to perform the actions of FIG. 2 with respective units that may be implemented as one or more applications running on one or more processors such as the processing circuitry 601.

Thus, the methods according to the embodiments described herein for the wireless device 130 may be respectively implemented by means of a computer program 605 product, comprising instructions, i.e., software code portions, which, when executed on at least one processing circuitry 601, cause the at least one processing circuitry 601 to carry out the actions described herein, as performed by the wireless device 130. The computer program 605 product may be stored on a computer-readable storage medium 606. The computer-readable storage medium 606, having stored thereon the computer program 605, may comprise instructions which, when executed on at least one processing circuitry 601, cause the at least one processing circuitry 601 to carry out the actions described herein, as performed by the wireless device 130. In some embodiments, the computer-readable storage medium 606 may be a non-transitory computer-readable storage medium, such as a CD ROM disc, or a memory stick. In other embodiments, the computer program 605 product may be stored on a carrier containing the computer program 605 just described, wherein the carrier is one of an electronic signal, optical signal, radio signal, or the computer-readable storage medium 606, as described above.

The wireless device 130 may comprise a communication interface configured to facilitate communications between the wireless device 130 and other nodes or devices, e.g., the network node 110 or another structure in the wireless communications network 100. The interface may, for example, include a transceiver configured to transmit and receive radio signals over an air interface in accordance with a suitable standard.

In other embodiments, the wireless device 130 may also comprise a radio circuitry 607, which may comprise e.g., the receiving port 603 and the sending port 604. The radio circuitry 607 may be configured to set up and maintain at least a wireless connection with the network node 110 or another structure in the wireless communications network 100. Circuitry may be understood herein as a hardware component.

Hence, embodiments herein also relate to the wireless device 130 comprising the processing circuitry 601 and the memory 602, said memory 602 containing instructions executable by said processing circuitry 601, whereby the wireless device 130 is operative to perform the actions described herein in relation to the wireless device 130, e.g., in FIG. 2.

FIG. 7 depicts an example of the arrangement that the network node 110 may comprise to perform the method actions described above in relation to FIG. 3. The network node 110 may be understood to be for handling the absence of an active connection to the wireless device 130. The network node 110 and the wireless device 130 may be configured to operate in the wireless communications network 100.

In some embodiments, the wireless communications network 100 may be configured to support NR.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the network node 110 and will thus not be repeated here. For example, the connected mode may be an RRC connected mode.

The network node 110 is configured and/or operable to perform the sending in Action 301, e.g. by means of a processing circuitry 701 within the network node 110 configured to, send the first indication to the wireless device 130. The first indication is configured to indicate that the wireless device 130 is to perform the estimation of the quality of the a radio channel between the wireless device 130 and the network node 110. The estimation is configured to be performed during a random access procedure in the absence of an active connection to the wireless device 130 and prior to the wireless device 130 receiving data from the network node 110.

The network node 110 is configured and/or operable to perform the receiving in Action 303, e.g. by means of the processing circuitry 701 within the network node 110 configured to, receive, based on the first indication configured to be sent and still in the absence of the active connection to the wireless device 130, the another indication from the wireless device 130. The another indication is configured to indicate the quality of the radio channel as estimated by the wireless device 130.

In some embodiments, the first indication may be configured to be one of: a) implicitly indicated, b) explicitly indicated, and c) broadcasted in the first cell 121 configured to be served by the network node 110, wherein the wireless device 130 may be configured to be located.

In some embodiments, one of the following may apply: a) the first indication may be configured to be implicitly indicated in the paging message sent by the network node 110, b) the first indication may be configured to be explicitly indicated by at least one of: the explicit indication in the paging message, and the one or more dedicated preambles, and c) the first indication may be configured to be broadcasted in system information.

The network node 110 may be further configured and/or operable to perform the sending in Action 302, e.g. by means of the processing circuitry 701 within the network node 110 configured to, send the second indication to the wireless device 130. The second indication may be configured to comprise the first uplink grant. The another indication may be configured to be received from the wireless device 130 in resources configured to be indicated in the first uplink grant configured to be sent.

In some embodiments, the first uplink grant may be configured to have a larger size than the second uplink grant, and one of the following may apply: a) the second indication may be configured to be sent after having sent the first indication to the wireless device 130, and the second uplink grant may be configured to be sent in another random access procedure wherein the first indication may be absent, ii) the second indication may be configured to be sent based on the presence of the wireless device 130 in the first cell 121 configured to be served by the network node 110, the first cell 121 being configured to support a Mobile Terminated Small Data Transmission procedure, and the second uplink grant may be configured to be sent in the second cell 122 configured to lack support for the Mobile Terminated Small Data Transmission procedure, and iii) the second indication may be configured to be sent with the proviso the network node 110 may have sent the first preamble, to the wireless device 130, of the one or more dedicated preambles for the wireless device 130, and received the first preamble back from the wireless device 130, and the second indication may be configured to not be sent with the proviso the network node 110 may not have sent the first preamble or not received the preamble back from the wireless device 130, and the second uplink grant may be configured to be sent in the absence of having received and/or sent the first preamble.

In some embodiments, at least one of the following may apply: a) the another indication may be configured to be indicated by the first preamble configured to be received from the wireless device 130 by the network node 110, b) the first preamble may be configured to be one of the plurality of preambles reserved for the wireless device 130, and c) the another indication may be configured to be received in the subsequent message to the random access response from the network node 110.

In some embodiments, the another indication may be configured to be received as one of: i) the information element in the RRC message, and ii) the MAC control element.

In some embodiments, the first uplink grant may be configured to have the same size than the second uplink grant configured to be sent in the another random access procedure wherein the first indication may be configured to be absent, and the first uplink grant may be configured to be sent, by the network node 110, after the network node 110 may have received, from the wireless device 130, the subsequent message to the random access response from the network node 110, and the first uplink grant may be configured to be sent for the wireless device 130 to send the another indication.

In some embodiments, one of the following may apply: a) the first indication may be configured to be comprised in the random access response in the random access procedure with the wireless device 130, and b) the first indication may be configured to be comprised in the random access response and may be the first uplink grant.

In some embodiments, the network node 110 may be further configured with at least one of the following three configurations.

The network node 110 may be configured and/or operable to perform the determining in Action 304, e.g. by means of the processing circuitry 701 within the network node 110 configured to, determine, based on the estimated quality of the radio channel configured to be indicated, whether to send the data during the random access procedure in the absence of an active connection to the wireless device 130 or after having established an active connection to the wireless device 130.

The network node 110 may be configured and/or operable to perform the sending in Action 305, e.g. by means of the processing circuitry 701 within the network node 110 configured to, send the third indication to the wireless device 130 based on the estimated quality of the radio channel configured to be indicated, the third indication being configured to indicate that the wireless device 130 may have to establish a connection with the network node 110.

The network node 110 may be configured and/or operable to perform the sending in Action 306, e.g. by means of the processing circuitry 701 within the network node 110 configured to, send data to the wireless device 130, wherein one of: i) in the absence of having sent the third indication, the data may be configured to be sent using the channel coding and modulation scheme, and resource allocation based on the indicated estimated quality of the radio channel, and ii) the data may be configured to be sent after having established the connection with the wireless device 130.

The embodiments herein in the network node 110 may be implemented through one or more processors, such as the processing circuitry 701 in the network node 110 depicted in FIG. 7a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The processing circuitry 701 may be configured to, or operable to, perform the method actions according to FIG. 3.

The network node 110 may further comprise a memory 702 comprising one or more memory units. The memory 702 is arranged to be used to store obtained information, store data, configurations, schedulings, and applications etc. to perform the methods herein when being executed in the network node 110.

In some embodiments, the network node 110 may receive information from, e.g., the wireless device 130 and/or another structure in the wireless communications network 100, through a receiving port 703. In some embodiments, the receiving port 703 may be, for example, connected to one or more antennas in network node 110. In other embodiments, the network node 110 may receive information from another structure in the wireless communications network 100 through the receiving port 703. Since the receiving port 703 may be in communication with the processing circuitry 701, the receiving port 703 may then send the received information to the processing circuitry 701. The receiving port 703 may also be configured to receive other information.

The processing circuitry 701 in the network node 110 may be further configured to transmit or send information to e.g., the wireless device 130 and/or another structure in the wireless communications network 100, through a sending port 704, which may be in communication with the processing circuitry 701, and the memory 702.

Those skilled in the art will also appreciate that the processing circuitry 701 described above may comprise a combination of analog and digital modules, and/or one or more processors configured with software and/or firmware, e.g., stored in memory, that, when executed by the one or more processors such as the processing circuitry 701, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the network node 110 may be configured to perform the actions of FIG. 3 with respective units that may be implemented as one or more applications running on one or more processors such as the processing circuitry 701.

Thus, the methods according to the embodiments described herein for the network node 110 may be respectively implemented by means of a computer program 705 product, comprising instructions, i.e., software code portions, which, when executed on at least one processing circuitry 701, cause the at least one processing circuitry 701 to carry out the actions described herein, as performed by the network node 110. The computer program 705 product may be stored on a computer-readable storage medium 706. The computer-readable storage medium 706, having stored thereon the computer program 705, may comprise instructions which, when executed on at least one processing circuitry 701, cause the at least one processing circuitry 701 to carry out the actions described herein, as performed by the network node 110. In some embodiments, the computer-readable storage medium 706 may be a non-transitory computer-readable storage medium, such as a CD ROM disc, or a memory stick. In other embodiments, the computer program 705 product may be stored on a carrier containing the computer program 705 just described, wherein the carrier is one of an electronic signal, optical signal, radio signal, or the computer-readable storage medium 706, as described above.

The network node 110 may comprise a communication interface configured to facilitate communications between the network node 110 and other nodes or devices, e.g., the wireless device 130 and/or another structure in the wireless communications network 100. The interface may, for example, include a transceiver configured to transmit and receive radio signals over an air interface in accordance with a suitable standard.

In other embodiments, the network node 110 may also comprise a radio circuitry 707, which may comprise e.g., the receiving port 703 and the sending port 704. The radio circuitry 707 may be configured to set up and maintain at least a wireless connection with the wireless device 130 and/or another structure in the wireless communications network 100. Circuitry may be understood herein as a hardware component.

Hence, embodiments herein also relate to the network node 110 comprising the processing circuitry 701 and the memory 702, said memory 702 containing instructions executable by said processing circuitry 701, whereby the network node 110 is operative to perform the actions described herein in relation to the network node 110, e.g., in FIG. 3.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

### Examples of, or Related to, Embodiments Herein

The wireless device 130 examples relate to FIG. 2, FIGS. 4-6 and FIGS. 8-10.

A method, performed by a wireless device, such as the wireless device 130 is described herein. The method may be understood to be for handling absence of an active connection to the network node 110. The wireless device 130 and the network node 110 may be operating in a wireless communications network, such as the wireless communications network 100.

In some examples related to embodiments herein, the wireless communications network 100 may support New Radio (NR).

The method may comprise one or more of the following actions. In some examples related to embodiments herein, all the actions may be performed. One or more examples related to embodiments herein may be combined, where applicable. Components from one example may be tacitly assumed to be present in another example and it will be obvious to a person skilled in the art how those components may be used in the other exemplary examples related to embodiments herein. All possible combinations are not described to simplify the description. A non-limiting example of the method performed by the wireless device 130 is depicted in FIG. 2. In FIG. 2 optional actions in some examples related to embodiments herein may be represented with dashed lines. In some examples related to embodiments herein, the actions may be performed in a different order than that depicted FIG. 2.
Obtaining 201 a first indication. The wireless device 130 may be configured and/or operable to perform the obtaining in this Action 201.

The obtaining in this Action 201 may be from the network node 110.

The first indication may indicate that the wireless device 130 is to perform an estimation of a quality of a radio channel between the wireless device 130 and the network node 110.

The estimation may have to be performed during a random access procedure in the absence of an active connection to the network node 110.

The estimation may have to be performed during the random access procedure in the absence of an active connection to the network node 110, and prior to the wireless device 130 receiving data from the network node 110.

The data may be small data, e.g., an SDT. Small data may be understood, for example, as data wherein a size of a buffer of the wireless device 130 for the uplink transmission of the data is smaller than a threshold.

In some examples related to embodiments herein, the first indication may be one of:
implicitly indicated, e.g., in a random access response message received from the network node 110,
explicitly indicated, e.g., in a paging message, and
broadcasted in a cell, such as the first cell 121 served by the network node 110, wherein the wireless device 130 may be located.

In some examples related to embodiments herein, one of the following may apply:
the first indication may be implicitly indicated in a paging message received from the network node 110, e.g., as indicated by a presence of a Mobile Terminated Small Data Transmission (MT-SDT) indication in the paging message,
the first indication may be explicitly indicated, e.g., by at least one of: an explicit indication in the paging message, and one or more preambles, e.g., one or more dedicated preambles, and
the first indication may be broadcasted in system information.
Estimating 203 the quality of the radio channel. The wireless device 130 may be configured and/or operable to perform the estimating in this Action 203.

The estimating of the quality of the radio channel in this Action 203 may be based on the obtained first indication. The estimating of the quality of the radio channel in this Action 203 may be based on the obtained first indication and still in the absence of the active connection to the network node 110.

The estimating of the quality of the radio channel in this Action 203 may be performed on: a) a random access response message, e.g., received from the network node 110 during the random access procedure, for example, on Msg2, and/or b) a paging message received from the network node 110, e.g., during the random access procedure. The random access procedure may be a 2 step or a 4 step random access procedure. The paging message may be, e.g., a paging message on the Paging CHannel (PCH).
Sending 204 another indication. The wireless device 130 may be configured and/or operable to perform the sending in this Action 204.

The sending in this Action 204 may be to the network node 110.

The sending in this Action 204 may be, e.g., transmitting, and may be performed, e.g., via the first link 141.

The another indication may indicate the estimated quality of the radio channel. The another indication may be, e.g., a DL quality report.

The sending in this Action 204 of the another indication may be based on the obtained first indication.

The sending in this Action 204 of the another indication may be based on the obtained first indication and still in the absence of the active connection to the network node 110.

In some examples related to embodiments herein, the method may further comprise one or more of the following actions:
Receiving 202 a second indication. The wireless device 130 may be configured and/or operable to perform the receiving in this Action 202.

The receiving in this Action 202 may be from the network node 110.

The receiving in this Action 202 may be performed, e.g., via the first link 141.

The second indication may comprise a first uplink grant. The first uplink grant may be, e.g., an Msg3 grant.

In some examples related to embodiments herein, the wireless device 130 may send the another indication in resources indicated in the received first uplink grant.

In some examples related to embodiments herein, the first uplink grant may have a larger size than a second uplink grant, e.g., to accommodate for a channel quality report.

In some examples related to embodiments herein, one of the following may apply:
i. the second indication may be received after having received the first indication from the network node 110, and the second uplink grant may be to be received in another random access procedure wherein the first indication is absent;
ii. the second indication may be received based on a presence of the wireless device 130 in the first cell 121 served by the network node 110; the first cell 121 may support a MT-SDT procedure; the second uplink grant may be to be received in a second cell, e.g., the second cell 122, lacking support for the MT-SDT procedure, and
iii. the second indication may be received with the proviso the wireless device 130 may have received a first preamble, e.g., CFRA preamble, of one or more dedicated preambles from the network node 110, and sent the first preamble back to the network node 110; the second indication may not be received with the proviso the wireless device 130 may not have received the first preamble or not sent the preamble back to the network node 110; the second uplink grant may be to be received in the absence of having received the first preamble.

In some examples related to embodiments herein, at least one of the following may apply:
the another indication may be indicated by the first preamble sent by the wireless device 130 to the network node 110,
the first preamble may be one of a plurality of preambles reserved for the wireless device 130, and
the another indication may be sent in a subsequent message to a random access response from the network node 110.

In some examples related to embodiments herein, the another indication may be sent as one of:
i. an information element in an RRC message, and
ii. a MAC control element.

In some examples related to embodiments herein, the first uplink grant may have a same size than the second uplink grant to be received in another random access procedure wherein the first indication may be absent. The first uplink grant may be received, by the wireless device 130, after the wireless device 130 may have sent a subsequent message to a random access response from the network node 110, and the first uplink grant may have been received to send the another indication.

In some examples related to embodiments herein, at least one of the following may apply:
the first indication may be comprised in a random access response in the random access procedure with the network node 110, and
the first indication may be comprised in the random access response and may be the first uplink grant.
Receiving 205 a third indication. The wireless device 130 may be configured and/or operable to perform the receiving in this Action 205.

The receiving in this Action 205 may be from the network node 110.

The receiving in this Action 205 may be performed, e.g., via the first link 141.

The third indication may indicate that the wireless device 130 may have to establish a connection with the network node 110, e.g., is to switch RRC Connected state.

The third indication may be based on the indicated estimated quality of the radio channel.
Receiving 206 data. The wireless device 130 may be configured and/or operable to perform the receiving in this Action 206.

The receiving in this Action 206 may be from the network node 110.

The receiving in this Action 206 may be performed, e.g., via the first link 141.

In some examples related to embodiments herein, one of the following may apply:
i. in the absence of having received the third indication, the data may be received using a channel coding and modulation scheme, and/or resource allocation based on the indicated estimated quality of the radio channel, and
ii. the data may be received after having established the connection with the network node 110, e.g., in RRC connected state.

In FIG. 2, optional units are indicated with dashed boxes.

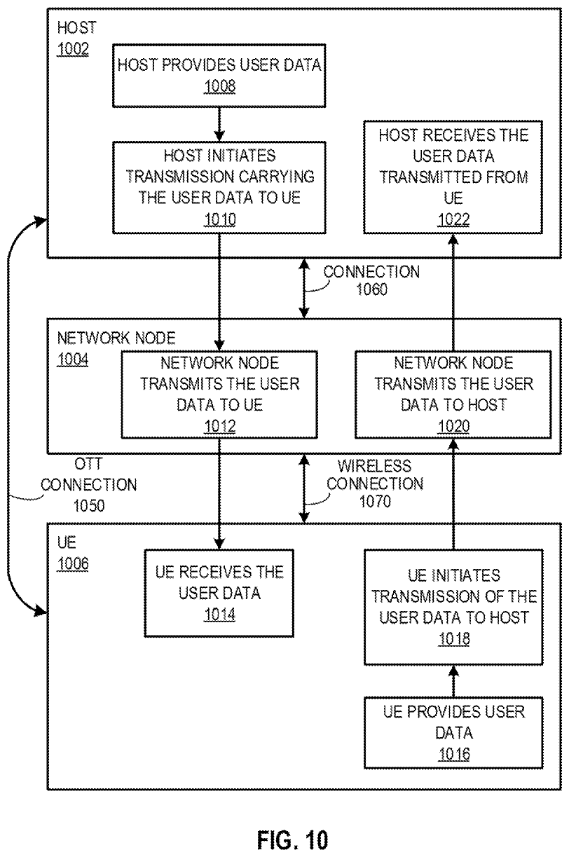

The wireless device 130 may comprise an arrangement as shown in FIG. 6 or in FIG. 10.

The network node 110 examples relate to FIG. 3, FIGS. 4-5, FIG. 7, and FIGS. 8-10.

A method, performed by a network node, such as the network node 110 is described herein. The method may be understood to be for handling the absence of an active connection to a wireless device 130. The network node 110 and the wireless device 130 may be operating in a wireless communications network, such as the wireless communications network 100.

In some examples related to embodiments herein, the wireless communications network 100 may support New Radio (NR).

The first method may comprise one or more of the following actions. In some examples related to embodiments herein, all the actions may be performed. One or more examples related to embodiments herein may be combined, where applicable. Components from one example may be tacitly assumed to be present in another example and it will be obvious to a person skilled in the art how those components may be used in the other exemplary examples related to embodiments herein. All possible combinations are not described to simplify the description. A non-limiting example of the method performed by the network node 110 is depicted in FIG. 3. In FIG. 3, optional actions in some examples related to embodiments herein may be represented with dashed lines. In some examples related to embodiments herein, the actions may be performed in a different order than that depicted FIG. 3.

The detailed description of some of the following corresponds to the same references provided above, in relation to the actions described for the wireless device 130 and will thus not be repeated here to simplify the description. For example, the active connection to the wireless device 130 may be an RRC Connected mode.
Sending 301 the first indication. The network node 110 may be configured and/or operable to perform the sending in this Action 301.

The sending in this Action 301 may be to the wireless device 130.

The sending in this Action 301 may be performed, e.g., via the first link 141.

The first indication may indicate that the wireless device 130 is to perform the estimation of the quality of the radio channel between the wireless device 130 and the network node 110.

The estimation may have to be performed during the random access procedure in the absence of an active connection to the network node 110.

The estimation may have to be performed during the random access procedure in the absence of an active connection to the network node 110, and prior to the wireless device 130 receiving data from the network node 110.

In some examples related to embodiments herein, the first indication may be one of:
implicitly indicated, e.g., in a random access response message sent by the network node 110,
explicitly indicated, e.g., in a paging message, and
broadcasted in a cell, such as the first cell 121 served by the network node 110,
wherein the wireless device 130 may be located.
Receiving 303 the another indication. The network node 110 may be configured and/or operable to perform the receiving in this Action 303.

The receiving in this Action 303 may be from the wireless device 130.

The receiving in this Action 303 may be performed, e.g., via the first link 141.

The another indication may indicate the quality of the radio channel as estimated by the wireless device 130.

The receiving in this Action 303 of the another indication may be based on the sent first indication.

The receiving in this Action 303 of the another indication may be based on the sent first indication and still in the absence of the active connection to the wireless device 130.

In some examples related to embodiments herein, one of the following may apply:
the first indication may be implicitly indicated in the paging message sent by the network node 110, e.g., as indicated by the presence of the MT-SDT indication in the paging message,
the first indication may be explicitly indicated, e.g., by at least one of: the explicit indication in the paging message, and the one or more preambles, e.g., the one or more dedicated preambles, and
the first indication may be broadcasted in system information.
Sending 302 the second indication. The network node 110 may be configured and/or operable to perform the sending in this Action 302.

The sending in this Action 302 may be to the wireless device 130.

The sending in this Action 302 may be performed, e.g., via the first link 141.

The second indication may comprise the first uplink grant.

In some examples related to embodiments herein, the another indication may be received from the wireless device 130 in resources indicated in the sent first uplink grant.

In some examples related to embodiments herein, the first uplink grant may have a larger size than the second uplink grant. In some examples related to embodiments herein, one of the following may apply:
i. the second indication may be sent after having sent the first indication to the wireless device 130, and the second uplink grant may be to be sent in the another random access procedure wherein the first indication may be absent;
ii. the second indication may be sent based on the presence of the wireless device 130 in the first cell 121 served by the network node 110; the first cell 121 may support the MT-SDT procedure; the second uplink grant may be to be sent in the second cell, e.g., the second cell 122, lacking support for the MT-SDT procedure, and
iii. the second indication may be sent with the proviso the network node 110 may have sent the first preamble, e.g., CFRA preamble, of one or more dedicated preambles for the wireless device 130, and received the first preamble back from the wireless device 130; the second indication may not be sent with the proviso the network node 110 may not have sent the first preamble or not received the preamble back from the wireless device 130; the second uplink grant may be to be sent in the absence of having received and/or sent the first preamble.

In some examples related to embodiments herein, at least one of the following may apply:
the another indication may be indicated by the first preamble received from the wireless device 130 by the network node 110,
the first preamble may be one of a plurality of preambles reserved for the wireless device 130, and
the another indication may be received in the subsequent message to the random access response from the network node 110.

In some examples related to embodiments herein, the another indication may be received as one of:
i. the information element in the RRC message, and
ii. the MAC control element.

In some examples related to embodiments herein, the first uplink grant may have the same size than the second uplink grant to be sent in the another random access procedure wherein the first indication may be absent. The first uplink grant may be sent, by the network node 110, after the network node 110 may have received the subsequent message to the random access response from the network node 110, and the first uplink grant may have been sent for the wireless device 130 to send the another indication.

In some examples related to embodiments herein, at least one of the following may apply:
the first indication may be comprised in the random access response in the random access procedure with the wireless device 130, and
the first indication may be comprised in the random access response and may be the first uplink grant.
Determining 304 how to send the data to the wireless device 130. The network node 110 may be configured and/or operable to perform the determining in this Action 304.

Determining may be understood as deciding, selecting, or similar.

The determining in this Action 304 may be based on the indicated estimated quality of the radio channel.

The determining in this Action 304 of how to send the data to the wireless device 130 may comprise determining e.g., whether to send the data the during the random access procedure in the absence of an active connection to the wireless device 130 or after having established an active connection to the wireless device 130, e.g., in RRC connected state.
Sending 305 the third indication. The network node 110 may be configured and/or operable to perform the sending in this Action 305.

The sending in this Action 305 may be to the wireless device 130.

The sending in this Action 305 may be performed, e.g., via the first link 141.

The third indication may indicate that the wireless device 130 may be to establish a connection with the network node 110, e.g., is to switch RRC Connected state.

The sending in this Action 305 may be based on the indicated estimated quality of the radio channel.
Sending 306 the data. The network node 110 may be configured and/or operable to perform the sending in this Action 306.

The sending in this Action 306 may be to the wireless device 130.

The sending in this Action 306 may be performed, e.g., via the first link 141.
i. in the absence of having sent the third indication, the data may be sent using the channel coding and modulation scheme, and/or resource allocation based on the indicated estimated quality of the radio channel, and
ii. the data may be sent after having established the connection with the wireless device 130, e.g., in RRC connected state.

In some examples, the network node 110 may perform link adaptation based on the received another indication. The network node 110 may perform the link adaptation after receiving the another indication and before sending the data in this Action 306.

In FIG. 7, optional units are indicated with dashed boxes.

The network node 110 may comprise an arrangement as shown in FIG. 7 or in FIG. 10.

Numbered examples related to embodiments herein may be as follows.

Example 1. A method performed by a wireless device (130), the method being for handling absence of an active connection to a network node (110), the wireless device (130) and the network node (110) operating in a wireless communications network (100), and the method comprising:
obtaining (201) a first indication from the network node (110), the first indication indicating that the wireless device (130) is to perform an estimation of a quality of a radio channel between the wireless device (130) and the network node (110), wherein the estimation is to be performed during a random access procedure in the absence of an active connection to the network node (110) and prior to the wireless device (130) receiving data from the network node (110),
estimating (203), based on the obtained first indication and still in the absence of the active connection to the network node (110), the quality of the radio channel, and
sending (204), based on the obtained first indication and still in the absence of the active connection to the network node (110), another indication to the network node (110), the another indication indicating the estimated quality of the radio channel.

Example 2. The method according to example 1, wherein the first indication is one of:
implicitly indicated, e.g., in a random access response message received from the network node (110),
explicitly indicated, e.g., in a paging message, and
broadcasted in a first cell (121) served by the network node (110), wherein the wireless device (130) is located.

Example 3. The method according to example 2, wherein one of:
the first indication is implicitly indicated in a paging message received from the network node (110), e.g., as indicated by a presence of a Mobile Terminated Small Data Transmission, MT-SDT, indication in the paging message,
the first indication is explicitly indicated by at least one of: an explicit indication in the paging message, and one or more dedicated preambles, and
the first indication is broadcasted in system information.

Example 4. The method according to any of examples 1-3, further comprising:
receiving (202) a second indication from the network node (110), wherein the second indication comprises a first uplink grant, and wherein the wireless device (130) sends the another indication in resources indicated in the received first uplink grant.

Example 5. The method according to example 4, wherein the first uplink grant has a larger size than a second uplink grant, and wherein one of:
i. the second indication is received after having received the first indication from the network node (110), and wherein the second uplink grant is to be received in another random access procedure wherein the first indication is absent,
ii. the second indication is received based on a presence of the wireless device (130) in a first cell (121) served by the network node (110), the first cell (121) supporting a Mobile Terminated Small Data Transmission procedure, and wherein the second uplink grant is to be received in a second cell (122) lacking support for the Mobile Terminated Small Data Transmission procedure, and
iii. the second indication is received with the proviso the wireless device (130) has received a first preamble, e.g., CFRA preamble, of one or more dedicated preambles from the network node (110), and sent the first preamble back to the network node (110), and the second indication is not received with the proviso the wireless device (130) has not received the first preamble or not sent the preamble back to the network node (110), and wherein the second uplink grant is to be received in the absence of having received the first preamble.

Example 6. The method according to any of examples 1-5, wherein at least one of:
the another indication is indicated by a first preamble sent by the wireless device (130) to the network node (110),
the first preamble is one of a plurality of preambles reserved for the wireless device (130), and
the another indication is sent in a subsequent message to a random access response from the network node (110).

Example 7. The method according to example 6, wherein the another indication is sent as one of:
i. an information element in an RRC message, and
ii. a MAC control element.

Example 8. The method according to example 4, wherein the first uplink grant has a same size than a second uplink grant to be received in another random access procedure wherein the first indication is absent, and wherein the first uplink grant is received, by the wireless device (130), after the wireless device (130) has sent a subsequent message to a random access response from the network node (110), and wherein the first uplink grant is received to send the another indication.

Example 9. The method according to any of examples 1-8, wherein one of:
the first indication is comprised in a random access response in the random access procedure with the network node (110), and
the first indication is comprised in the random access response and is the first uplink grant.

Example 10. The method according to any of examples 1-9, further comprising at least one of:
receiving (205) a third indication from the network node (110) based on the indicated estimated quality of the radio channel, the third indication indicating that the wireless device (130) is to establish a connection with the network node (110), e.g., is to switch RRC Connected state, and
receiving (206) data from the network node (110), wherein one of:
   i. in the absence of having received the third indication, the data is received using a channel coding and modulation scheme, and resource allocation based on the indicated estimated quality of the radio channel, and
   ii. the data is received after having established the connection with the network node (110), e.g., in RRC connected state.

Example 11. A method performed by a network node (110), the method being for handling absence of an active connection to a wireless device (130), the network node (110) and the wireless device (130) operating in a wireless communications network (100), and the method comprising:
sending (301) a first indication to the wireless device (130), the first indication indicating that the wireless device (130) is to perform an estimation of a quality of a radio channel between the wireless device (130) and the network node (110), wherein the estimation is to be performed during a random access procedure in the absence of an active connection to the wireless device (130) and prior to the wireless device (130) receiving data from the network node (110),
receiving (303), based on the sent first indication and still in the absence of the active connection to the wireless device (130), another indication from the wireless device (130), the another indication indicating the quality of the radio channel as estimated by the wireless device (130).

Example 12. The method according to example 11, wherein the first indication is one of:
implicitly indicated, e.g., in a random access response message sent by the network node (110),
explicitly indicated, e.g., in a paging message, and
broadcasted in a first cell (121) served by the network node (110), wherein the wireless device (130) is located.

Example 13. The method according to example 12, wherein one of:
the first indication is implicitly indicated in a paging message sent by the network node (110), e.g., as indicated by a presence of a Mobile Terminated Small Data Transmission, MT-SDT, indication in the paging message,
the first indication is explicitly indicated by at least one of: an explicit indication in the paging message, and one or more dedicated preambles, and
the first indication is broadcasted in system information.

Example 14. The method according to any of examples 11-13, further comprising:
sending (302) a second indication to the wireless device (130), wherein the second indication comprises a first uplink grant, and wherein the another indication is received from the wireless device (130) in resources indicated in the sent first uplink grant.

Example 15. The method according to example 14, wherein the first uplink grant has a larger size than a second uplink grant, and wherein one of:
i. the second indication is sent after having sent the first indication to the wireless device (130), and wherein the second uplink grant is to be sent in another random access procedure wherein the first indication is absent,
ii. the second indication is sent based on a presence of the wireless device (130) in a first cell (121) served by the network node (110), the first cell (121) supporting a Mobile Terminated Small Data Transmission procedure, and wherein the second uplink grant is to be sent in a second cell (122) lacking support for the Mobile Terminated Small Data Transmission procedure, and
iii. the second indication is sent with the proviso the network node (110) has sent a first preamble, e.g., CFRA preamble, to the wireless device 130, of one or more dedicated preambles for the wireless device (130), and received the first preamble back from the wireless device (130), and the second indication is not sent with the proviso the network node (110) has not sent the first preamble or not received the preamble back from the wireless device (130), and wherein the second uplink grant is to be sent in the absence of having received and/or sent the first preamble.

Example 16. The method according to any of examples 11-15, wherein at least one of:
the another indication is indicated by a first preamble received from the wireless device (130) by the network node (110),
the first preamble is one of a plurality of preambles reserved for the wireless device (130), and
the another indication is received in a subsequent message to a random access response from the network node (110).

Example 17. The method according to example 16, wherein the another indication is received as one of:
i. an information element in an RRC message, and
ii. a MAC control element.

Example 18. The method according to example 14, wherein the first uplink grant has a same size than a second uplink grant to be sent in another random access procedure wherein the first indication is absent, and wherein the first uplink grant is sent, by the network node (110), after the network node (110) has received, from the wireless device (130), a subsequent message to a random access response from the network node (110), and wherein the first uplink grant is sent for the wireless device (130) to send the another indication.

Example 19. The method according to any of examples 11-18, wherein one of:
the first indication is comprised in a random access response in the random access procedure with the wireless device (130), and
the first indication is comprised in the random access response and is the first uplink grant.

Example 20. The method according to any of examples 11-19, further comprising at least one
determining (304), based on the indicated estimated quality of the radio channel, how to send data to the wireless device (130), e.g., whether to send the data during the random access procedure in the absence of an active connection to the wireless device (130) or after having established an active connection to the wireless device (130), e.g., in RRC connected state,
sending (305) a third indication to the wireless device (130) based on the indicated estimated quality of the radio channel, the third indication indicating that the wireless device (130) is to establish a connection with the network node (110), e.g., is to switch RRC Connected state, and
sending (306) data to the wireless device (130), wherein one of:
   i. in the absence of having sent the third indication, the data is sent using a channel coding and modulation scheme, and resource allocation based on the indicated estimated quality of the radio channel, and
   ii. the data is sent after having established the connection with the wireless device (130), e.g., in RRC connected state.

### Further Extensions and Variations

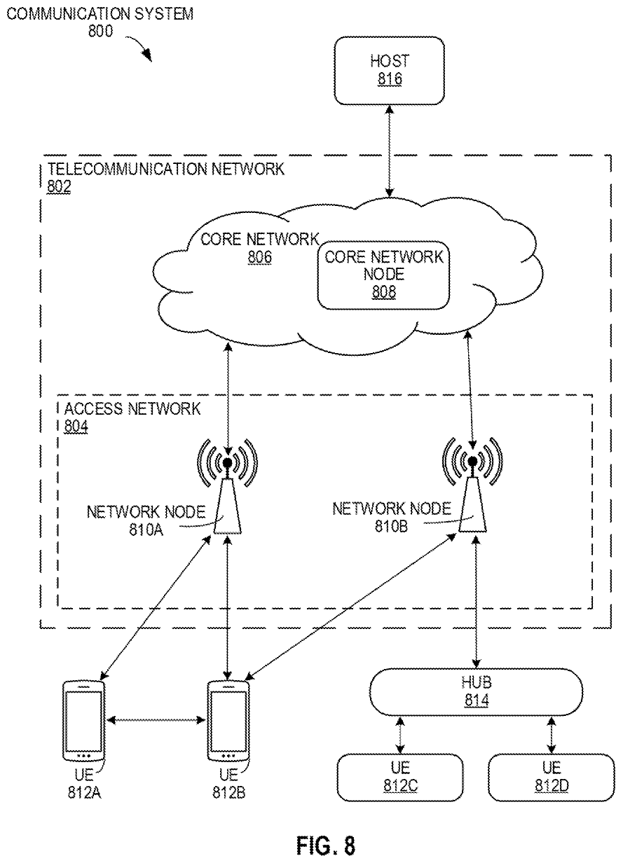

FIG. 8 shows an example of a communication system 800 in accordance with some embodiments.

In the example, the communication system 800, such as the wireless communications network 100, includes a telecommunication network 802 that includes an access network 804, such as a radio access network (RAN), and a core network 806, which includes one or more core network nodes 808. The access network 804 includes one or more access network nodes, such as the network node 110. For example, network nodes 810a and 810b, one or more of which may be generally referred to as network nodes 810, or any other similar 3^{rd} Generation Partnership Project (3GPP) access node or non-3GPP access point. The communications system 800 comprises a plurality of wireless devices, such as the wireless device 130. In FIG. 8, the plurality of wireless devices comprises UEs 812a, 812b, 812c, and 812d, one or more of which may be generally referred to as UEs 812. The network nodes 810 facilitate direct or indirect connection of user equipment (UE), such as by connecting UEs 812a, 812b, 812c, and 812d to the core network 806 over one or more wireless connections. Any of the UEs 812a, 812b, 812c, and 812d are examples of the wireless device 130.

In relation to FIGS. 8, 9, and 10, which are described next, it may be understood that any UE is an example of the wireless device 130, and that any description provided for the UE 812 or for the UE 1006 equally applies to the wireless device 130. It may be also understood that any network node is an example of the network node 110, and that any description provided for any network node 810 or for the network node 1004 equally applies to the network node 110. It may further be understood that the communication system 800 is an example of the wireless communication network 100, and that any description provided for the communication system 800 equally applies to the wireless communication network 100.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The wireless device 130, exemplified in FIG. 8 as the UEs 812, may be any of a wide variety of communication devices, including wireless devices arranged, configured, and/or operable to communicate wirelessly with the network node 110, exemplified in FIG. 8 as network nodes 810, and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes, e.g., core network node 808, that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802 and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 802 is a cellular network that implements 3GPP standardized features. Accordingly, the telecommunications network 802 may support network slicing to provide different logical networks to different devices that are connected to the telecommunication network 802. For example, the telecommunications network 802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single- or multi-RAT or multi-standard mode. For example, a UE may operate with any one or combination of Wi-Fi, New Radio (NR) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 814 communicates with the access network 804 to facilitate indirect communication between one or more UEs, e.g., UE 812c and/or 812d, and network nodes, e.g., network node 810b. In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a VR headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular in if one or more of the UEs are low energy IoT devices.

The hub 814 may have a constant/persistent or intermittent connection to the network node 810b. The hub 814 may also allow for a different communication scheme and/or schedule between the hub 814 and UEs (e.g., UE 812c and/or 812d), and between the hub 814 and the core network 806. In other examples, the hub 814 is connected to the core network 806 and/or one or more UEs via a wired connection. Moreover, the hub 814 may be configured to connect to an M2M service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub-that is, a hub whose primary function is to route communications to/from the UEs from/to the network node 810b. In other embodiments, the hub 814 may be a non-dedicated hub—that is, a device which is capable of operating to route communications between the UEs and network node 810b, but which is additionally capable of operating as a communication start and/or end point for certain data channels.

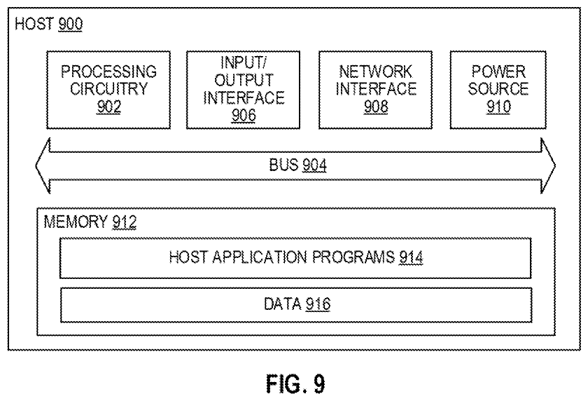

FIG. 9 is a block diagram of a host 900, which may be an embodiment of the host 816 of FIG. 8, in accordance with various aspects described herein. As used herein, the host 900 may be or comprise various combinations hardware and/or software, including a standalone server, a blade server, a cloud-implemented server, a distributed server, a virtual machine, container, or processing resources in a server farm. The host 900 may provide one or more services to one or more UEs.

The host 900 includes processing circuitry 902 that is operatively coupled via a bus 904 to an input/output interface 906, a network interface 908, a power source 910, and a memory 912. Other components may be included in other embodiments. Features of these components may be substantially similar to those described with respect to the devices of previous figures, such that the descriptions thereof are generally applicable to the corresponding components of host 900.

The memory 912 may include one or more computer programs including one or more host application programs 914 and data 916, which may include user data, e.g., data generated by a UE for the host 900 or data generated by the host 900 for a UE. Embodiments of the host 900 may utilize only a subset or all of the components shown. The host application programs 914 may be implemented in a container-based architecture and may provide support for video codecs, (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 914 may also provide for user authentication and licensing checks and may periodically report health, routes, and content availability to a central node, such as a device in or on the edge of a core network. Accordingly, the host 900 may select and/or indicate a different host for over-the-top services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 10 shows a communication diagram of a host 1002 communicating via a network node 1004 with a UE 1006 over a partially wireless connection in accordance with some embodiments. Example implementations, in accordance with various embodiments, of the UE, such as a UE 812a of FIG. 8, network node, such as network node 810a of FIG. 8, and host, such as host 816 of FIG. 8 and/or host 900 of FIG. 9, discussed in the preceding paragraphs will now be described with reference to FIG. 10.

Like host 900, embodiments of host 1002 include hardware, such as a communication interface, processing circuitry, and memory. The host 1002 also includes software, which is stored in or accessible by the host 1002 and executable by the processing circuitry. The software includes a host application that may be operable to provide a service to a remote user, such as the UE 1006 connecting via an over-the-top (OTT) connection 1050 extending between the UE 1006 and host 1002. In providing the service to the remote user, a host application may provide user data which is transmitted using the OTT connection 1050.

The network node 1004 includes hardware enabling it to communicate with the host 1002 and UE 1006. The connection 1060 may be direct or pass through a core network (like core network 806 of FIG. 8) and/or one or more other intermediate networks, such as one or more public, private, or hosted networks. For example, an intermediate network may be a backbone network or the Internet.

The UE 1006 includes hardware and software, which is stored in or accessible by UE 1006 and executable by the UE's processing circuitry. The software includes a client application, such as a web browser or operator-specific “app” that may be operable to provide a service to a human or non-human user via UE 1006 with the support of the host 1002. In the host 1002, an executing host application may communicate with the executing client application via the OTT connection 1050 terminating at the UE 1006 and host 1002. In providing the service to the user, the UE's client application may receive request data from the host's host application and provide user data in response to the request data. The OTT connection 1050 may transfer both the request data and the user data. The UE's client application may interact with the user to generate the user data that it provides to the host application through the OTT connection 1050.

The OTT connection 1050 may extend via a connection 1060 between the host 1002 and the network node 1004 and via a wireless connection 1070 between the network node 1004 and the UE 1006 to provide the connection between the host 1002 and the UE 1006. The connection 1060 and wireless connection 1070, over which the OTT connection 1050 may be provided, have been drawn abstractly to illustrate the communication between the host 1002 and the UE 1006 via the network node 1004, without explicit reference to any intermediary devices and the precise routing of messages via these devices.

As an example of transmitting data via the OTT connection 1050, in step 1008, the host 1002 provides user data, which may be performed by executing a host application. In some embodiments, the user data is associated with a particular human user interacting with the UE 1006. In other embodiments, the user data is associated with a UE 1006 that shares data with the host 1002 without explicit human interaction. In step 1010, the host 1002 initiates a transmission carrying the user data towards the UE 1006. The host 1002 may initiate the transmission responsive to a request transmitted by the UE 1006. The request may be caused by human interaction with the UE 1006 or by operation of the client application executing on the UE 1006. The transmission may pass via the network node 1004, in accordance with the teachings of the embodiments described throughout this disclosure. Accordingly, in step 1012, the network node 1004 transmits to the UE 1006 the user data that was carried in the transmission that the host 1002 initiated, in accordance with the teachings of the embodiments described throughout this disclosure. In step 1014, the UE 1006 receives the user data carried in the transmission, which may be performed by a client application executed on the UE 1006 associated with the host application executed by the host 1002.

In some examples, the UE 1006 executes a client application which provides user data to the host 1002. The user data may be provided in reaction or response to the data received from the host 1002. Accordingly, in step 1016, the UE 1006 may provide user data, which may be performed by executing the client application. In providing the user data, the client application may further consider user input received from the user via an input/output interface of the UE 1006. Regardless of the specific manner in which the user data was provided, the UE 1006 initiates, in step 1018, transmission of the user data towards the host 1002 via the network node 1004. In step 1020, in accordance with the teachings of the embodiments described throughout this disclosure, the network node 1004 receives user data from the UE 1006 and initiates transmission of the received user data towards the host 1002. In step 1022, the host 1002 receives the user data carried in the transmission initiated by the UE 1006.

One or more of the various embodiments improve the performance of OTT services provided to the UE 1006 using the OTT connection 1050, in which the wireless connection 1070 forms the last segment. More precisely, the teachings of these embodiments may improve the data rate, latency, power consumption and thereby provide benefits such as reduced user waiting time, relaxed restriction on file size, improved content resolution, better responsiveness, and extended battery lifetime.

In an example scenario, factory status information may be collected and analyzed by the host 1002. As another example, the host 1002 may process audio and video data which may have been retrieved from a UE for use in creating maps. As another example, the host 1002 may collect and analyze real-time data to assist in controlling vehicle congestion, e.g., controlling traffic lights. As another example, the host 1002 may store surveillance video uploaded by a UE. As another example, the host 1002 may store or control access to media content such as video, audio, VR or AR which it can broadcast, multicast or unicast to UEs. As other examples, the host 1002 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1050 between the host 1002 and UE 1006, in response to variations in the measurement results. The measurement procedure and/or the network functionality for reconfiguring the OTT connection may be implemented in software and hardware of the host 1002 and/or UE 1006. In some embodiments, sensors, not shown, may be deployed in or in association with other devices through which the OTT connection 1050 passes; the sensors may participate in the measurement procedure by supplying values of the monitored quantities exemplified above, or supplying values of other physical quantities from which software may compute or estimate the monitored quantities. The reconfiguring of the OTT connection 1050 may include message format, retransmission settings, preferred routing etc.; the reconfiguring need not directly alter the operation of the network node 1004. Such procedures and functionalities may be known and practiced in the art. In certain embodiments, measurements may involve proprietary UE signaling that facilitates measurements of throughput, propagation times, latency and the like, by the host 1002. The measurements may be implemented in that software causes messages to be transmitted, in particular empty or ‘dummy’ messages, using the OTT connection 1050 while monitoring propagation times, errors, etc.

The wireless device 130 embodiments relate to FIG. 2, FIGS. 4-6 and FIGS. 8-10.

The wireless device 130 may comprise an arrangement as shown in FIG. 6 or in FIG. 10.

The network node 110 embodiments relate to FIG. 3, FIGS. 4-5, FIG. 7, and FIGS. 8-10.

The network node 110 may comprise an arrangement as shown in FIG. 7 or in FIG. 10.

### Further Numbered Embodiments

1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform one or more of the actions described herein as performed by the network node 110.

2. The host of the previous embodiment, wherein:
the processing circuitry of the host is configured to execute a host application that provides the user data; and
the UE comprises processing circuitry configured to execute a client application associated with the host application to receive the transmission of user data from the host.

3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs one or more of the actions described herein as performed by the network node 110.

4. The method of the previous embodiment, further comprising, at the network node, transmitting the user data provided by the host for the UE.

5. The method of any of the previous 2 embodiments, wherein the user data is provided at the host by executing a host application that interacts with a client application executing on the UE, the client application being associated with the host application.

6. a Communication System Configured to Provide an Over-the-top Service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform one or more of the actions described herein as performed by the network node 110.

7. The communication system of the previous embodiment, further comprising:
the network node; and/or
the user equipment.

8. The communication system of the previous 2 embodiments, wherein:
the processing circuitry of the host is configured to execute a host application, thereby providing the user data; and
the host application is configured to interact with a client application executing on the UE, the client application being associated with the host application.

9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform one or more of the actions described herein as performed by the network node 110.

10. The host of the previous 2 embodiments, wherein:
the processing circuitry of the host is configured to execute a host application, thereby providing the user data; and
the host application is configured to interact with a client application executing on the UE, the client application being associated with the host application.

11. The host of the any of the previous 2 embodiments, wherein the initiating receipt of the user data comprises requesting the user data.

12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs one or more of the actions described herein as performed by the network node 110.

13. The method of the previous embodiment, further comprising at the network node, transmitting the received user data to the host.

14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform one or more of the actions described herein as performed by the wireless device 130.

15. The host of the previous embodiment, wherein the cellular network further includes a network node configured to communicate with the UE to transmit the user data to the UE from the host.

16. The host of the previous 2 embodiments, wherein:
the processing circuitry of the host is configured to execute a host application, thereby providing the user data; and
the host application is configured to interact with a client application executing on the UE, the client application being associated with the host application.

17. A method implemented by a host operating in a communication system that further includes a network node and a user equipment (UE), the method comprising:
providing user data for the UE; and
initiating a transmission carrying the user data to the UE via a cellular network comprising the network node, wherein the UE performs one or more of the actions described herein as performed by the wireless device 130.

18. The method of the previous embodiment, further comprising:
at the host, executing a host application associated with a client application executing on the UE to receive the user data from the UE.

19. The method of the previous embodiment, further comprising:
at the host, transmitting input data to the client application executing on the UE, the input data being provided by executing the host application,
wherein the user data is provided by the client application in response to the input data from the host application.

20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform one or more of the actions described herein as performed by the wireless device 130.

21. The host of the previous embodiment, wherein the cellular network further includes a network node configured to communicate with the UE to transmit the user data from the UE to the host.

22. The host of the previous 2 embodiments, wherein:
the processing circuitry of the host is configured to execute a host application, thereby providing the user data; and
the host application is configured to interact with a client application executing on the UE, the client application being associated with the host application.

23. A method implemented by a host configured to operate in a communication system that further includes a network node and a user equipment (UE), the method comprising:
at the host, receiving user data transmitted to the host via the network node by the UE, wherein the UE performs one or more of the actions described herein as performed by the wireless device 130.

24. The method of the previous embodiment, further comprising:
at the host, executing a host application associated with a client application executing on the UE to receive the user data from the UE.

25. The method of the previous embodiments, further comprising:
at the host, transmitting input data to the client application executing on the UE, the input data being provided by executing the host application,
wherein the user data is provided by the client application in response to the input data from the host application.

1-40. (canceled)

41. A method performed by a wireless device, the method being for handling absence of an active connection to a network node, the wireless device and the network node operating in a wireless communications network, and the method comprising:
obtaining a first indication from the network node, the first indication indicating that the wireless device is to perform an estimation of a quality of a radio channel between the wireless device and the network node, wherein the estimation is to be performed during a random access procedure in the absence of an active connection to the network node and prior to the wireless device receiving data from the network node;
estimating, based on the obtained first indication and still in the absence of the active connection to the network node, the quality of the radio channel; and
sending, based on the obtained first indication and still in the absence of the active connection to the network node, another indication to the network node, the other indication indicating the estimated quality of the radio channel.

42. The method according to claim 41, wherein the first indication is implicitly indicated or explicitly indicated or broadcasted in a first cell served by the network node, wherein the wireless device is located.

43. The method according to claim 42, wherein:
the first indication is implicitly indicated in a paging message received from the network node;
the first indication is explicitly indicated by at least one of: an explicit indication in a paging message, and one or more dedicated preambles; or
the first indication is broadcasted in system information.

44. The method according to claim 41, further comprising receiving a second indication from the network node, wherein the second indication comprises a first uplink grant, and wherein the wireless device sends the other indication in resources indicated in the received first uplink grant.

45. The method according to claim 44, wherein the first uplink grant has a larger size than a second uplink grant, and wherein one of:
the second indication is received after having received the first indication from the network node, and wherein the second uplink grant is to be received in another random access procedure wherein the first indication is absent;
the second indication is received based on a presence of the wireless device in a first cell served by the network node, the first cell supporting a Mobile Terminated Small Data Transmission procedure, and wherein the second uplink grant is to be received in a second cell lacking support for the Mobile Terminated Small Data Transmission procedure; or
the second indication is received with the proviso the wireless device has received a first preamble, of one or more dedicated preambles from the network node, and sent the first preamble back to the network node, and the second indication is not received with the proviso the wireless device has not received the first preamble or not sent the preamble back to the network node, and wherein the second uplink grant is to be received in the absence of having received the first preamble.

46. The method according to claim 41, wherein at least one of:
the other indication is indicated by a first preamble sent by the wireless device to the network node;
the first preamble is one of a plurality of preambles reserved for the wireless device; and
the other indication is sent in a subsequent message to a random access response from the network node.

47. The method according to claim 46, wherein the other indication is sent as an information element in an RRC message or as a MAC control element.

48. The method according to claim 44, wherein the first uplink grant has a same size than a second uplink grant to be received in another random access procedure wherein the first indication is absent, and wherein the first uplink grant is received, by the wireless device, after the wireless device has sent a subsequent message to a random access response from the network node, and wherein the first uplink grant is received to send the other indication.

49. The method according to claim 41, wherein the first indication is comprised in a random access response in the random access procedure with the network node, the first indication is comprised in the random access response and is the first uplink grant.

50. The method according to claim 41, further comprising at least one of:
receiving a third indication from the network node based on the indicated estimated quality of the radio channel, the third indication indicating that the wireless device is to establish a connection with the network node; and
receiving data from the network node, wherein:
in the absence of having received the third indication, the data is received using a channel coding and modulation scheme, and resource allocation based on the indicated estimated quality of the radio channel; or
the data is received after having established the connection with the network node.

51. A method performed by a network node, the method being for handling absence of an active connection to a wireless device, the network node and the wireless device operating in a wireless communications network, and the method comprising:
sending a first indication to the wireless device, the first indication indicating that the wireless device is to perform an estimation of a quality of a radio channel between the wireless device and the network node, wherein the estimation is to be performed during a random access procedure in the absence of an active connection to the wireless device and prior to the wireless device receiving data from the network node,
receiving, based on the sent first indication and still in the absence of the active connection to the wireless device, another indication from the wireless device, the other indication indicating the quality of the radio channel as estimated by the wireless device.

52. The method according to claim 51, wherein the first indication is one of:
implicitly indicated;
explicitly indicated; or
broadcasted in a first cell served by the network node, wherein the wireless device is located.

53. The method according to claim 52, wherein one of:
the first indication is implicitly indicated in a paging message sent by the network node;
the first indication is explicitly indicated by at least one of: an explicit indication in the paging message, and one or more dedicated preambles; or
the first indication is broadcasted in system information.

54. The method according to claim 51, further comprising sending a second indication to the wireless device, wherein the second indication comprises a first uplink grant, and wherein the other indication is received from the wireless device in resources indicated in the sent first uplink grant.

55. The method according to claim 54, wherein the first uplink grant has a larger size than a second uplink grant, and wherein one of:
the second indication is sent after having sent the first indication to the wireless device, and wherein the second uplink grant is to be sent in another random access procedure wherein the first indication is absent;
the second indication is sent based on a presence of the wireless device in a first cell served by the network node, the first cell supporting a Mobile Terminated Small Data Transmission procedure, and wherein the second uplink grant is to be sent in a second cell lacking support for the Mobile Terminated Small Data Transmission procedure; or
the second indication is sent with the proviso the network node has sent a first preamble, to the wireless device, of one or more dedicated preambles for the wireless device, and received the first preamble back from the wireless device, and the second indication is not sent with the proviso the network node has not sent the first preamble or not received the preamble back from the wireless device, and wherein the second uplink grant is to be sent in the absence of having received and/or sent the first preamble.

56. The method according to claim 51, wherein at least one of:
the other indication is indicated by a first preamble received from the wireless device by the network node;
the first preamble is one of a plurality of preambles reserved for the wireless device; and
the other indication is received in a subsequent message to a random access response from the network node.

57. The method according to claim 56, wherein the other indication is received as one of an information element in an RRC message or as a MAC control element.

58. The method according to claim 54, wherein the first uplink grant has a same size than a second uplink grant to be sent in another random access procedure wherein the first indication is absent, and wherein the first uplink grant is sent, by the network node, after the network node has received, from the wireless device, a subsequent message to a random access response from the network node, and wherein the first uplink grant is sent for the wireless device to send the other indication.

59. The method according to claim 51, wherein one of:
the first indication is comprised in a random access response in the random access procedure with the wireless device; or
the first indication is comprised in the random access response and is the first uplink grant.

60. The method according to claim 51, further comprising at least one of:
determining, based on the indicated estimated quality of the radio channel, whether to send the data during the random access procedure in the absence of an active connection to the wireless device or after having established an active connection to the wireless device;
sending a third indication to the wireless device based on the indicated estimated quality of the radio channel, the third indication indicating that the wireless device is to establish a connection with the network node; and
sending data to the wireless device, wherein one of:
in the absence of having sent the third indication, the data is sent using a channel coding and modulation scheme, and resource allocation based on the indicated estimated quality of the radio channel; and
the data is sent after having established the connection with the wireless device.

61. A wireless device configured to operate in a wireless communications network, the wireless device comprising:
radio circuitry; and
processing circuitry configured to:
obtain, via the radio circuitry, a first indication from the network node, indicating that the wireless device is to perform an estimation of a quality of a radio channel between the wireless device and a network node of the wireless communications network during a random access procedure, in the absence of an active connection to the network node and prior to the wireless device receiving data from the network node;
estimate the quality of the radio channel, in response to the first indication and still in the absence of the active connection to the network node; and
send an indication of the estimated quality of the radio channel to the network node via the radio circuitry, while still in the absence of the active connection to the network node.

62. A network node configured to operate in a wireless communications network, and the network node comprising:
radio circuitry; and
processing circuitry configured to:
send a first indication to the wireless device via the radio circuitry, indicating that the wireless device is to perform an estimation of a quality of a radio channel between the wireless device and the network node during a random access procedure in the absence of an active connection to the wireless device and prior to the wireless device receiving data from the network node; and
receive another indication from the wireless device via the radio circuitry, still in the absence of the active connection to the wireless device, the other indication indicating an estimation by the wireless device of the quality of the radio channel.
